(19) United States
(12) Patent Application Publication
(10) Pub. No.: US 2013/0081885 A1
(43) Pub. Date: Apr. 4, 2013

(54) Transformability(TM): personal mobility with shape-changing wheels

(71) Applicant: Robert A. Connor, Minneapolis, MN (US)

(72) Inventor: Robert A. Connor, Minneapolis, MN (US)

(21) Appl. No.: 13/200,886

(22) Filed: Oct. 3, 2011

(51) Int. Cl. A61G 5/06; B62D 63/04

(52) U.S. Cl. 180/8.2

(57) ABSTRACT

This present invention is a personal mobility device for transporting a person over different surfaces and obstacles. This invention comprises novel technology that can be used for next-generation motorized wheelchairs that enable people to travel outside during winter months, to go “off-road,” and to travel up and down staircases independently. This invention features shape-changing wheels that change shape to travel more effectively on different surfaces and obstacles. The shape of a shape-changing wheel is changed by the motorized rotation of at least two rotating members that are part of the shape-changing wheel. Rotation of these rotating members into a first configuration causes the ground-contacting perimeter of the wheel to be circular. Rotation of these rotating members into a second configuration causes the ground-contacting perimeter of the wheel to be non-circular.

### CROSS-REFERENCE TO RELATED APPLICATIONS

This patent application claims the priority benefits of: U.S. patent application Ser. No. 12/589,407 entitled “Reinventing the Wheel” filed on Oct. 24, 2009 by Robert A. Connor of Medibotics LLC, Minnesota.

### FEDERALLY SPONSORED RESEARCH

Not Applicable

### SEQUENCE LISTING OR PROGRAM

Not Applicable

### BACKGROUND—FIELD OF INVENTION

This invention relates to the field of personal mobility.

### INTRODUCTION

The invention that is disclosed herein is in the field of personal mobility, especially with respect to motorized wheelchairs that can transport a person who is sitting down and gyroscopically-enhanced personal mobility devices that can transport a person who is standing up. Although considerable progress has been made in the past few decades with respect to personal mobility devices, there is still an unmet need for next-generation personal mobility devices that enable a person who cannot walk independently to travel outside during winter months, to travel “off-road” in rustic areas, and to travel up. (and down) staircases independently.

Circular wheels tend to be optimal for traveling over flat, hard, dry surfaces. However, non-circular wheels, such as those with angular protrusions, tend to be optimal for traveling on slippery surfaces and for climbing obstacles such as staircases. There is still an unmet need for a personal mobility device with one or more shape-changing wheels that can transition smoothly and automatically, from having wheels with a circular configuration to having wheels with a non-circular configuration in order to travel more effectively over different surfaces and obstacles. This present invention, a motorized personal mobility device with shape-changing wheels, can meet this need.

### CATEGORIZATION AND LIMITATIONS OF THE PRIOR ART

It is challenging to classify the prior art into discrete categories, especially when examples of potentially relevant prior art number in the hundreds. However, such classification of the prior art into categories, even if imperfect, is an invaluable tool for reviewing the prior art, identifying the limitations of the prior art, and setting the stage for discussion of the advantages of the present invention in subsequent sections.

Towards this end, I have identified nine general device categories, identified key limitations of devices in these categories, and identified examples of prior art which appear to be best classified into these categories. The nine general categories are: devices with wheels with extendable/retractable spikes/spokes; devices with wheels with differentially inflatable/deformable perimeter segments; devices with wheels with differentially-inflatable parallel adjacent tires; devices with wheels with foldable/bendable perimeter segments; devices with wheels with differentially-expandable concentric rings; devices with compound wheels or multiple interacting circular wheels; devices with multiple interacting non-circular wheels; devices with endless-loop tracks; and devices with walking legs. I also report of a list examples of prior art that appear to be generally relevant to the field of this invention but do not fit neatly into one of these nine categories.

1. Devices with Wheels with Extendable/Retractable Spikes/Spokes

The first category (#1) of relevant prior art includes devices with wheels with spikes/spokes that can be extended outwards from this wheel into contact with the ground (or retracted into the wheel away from contact with the ground): (#1a) in radial manner through holes in the main wheel perimeter; (#1b) in a non-radial angular manner (as with a spider wheel) through holes in the main wheel perimeter; (#1c) in a radial manner through an opening between two parallel wheels; (#1d) in a non-radial angular manner (as with a spider wheel) through an opening between two parallel wheels; (#1e) in a radial manner from a mechanism on the side of a wheel; (#1f) in a laterally-rotating manner from a mechanism on the side of a wheel; (#1g) in a non-radial angular manner (as with a spider wheel) from a mechanism on the side of a wheel; or (#1h) in a radial manner, unaccompanied by any main wheel perimeter. I now discuss the limitations of devices in each of these sub-categories.

For devices in sub-category #1a: there are limitations on the number and width of spikes/spokes because numerous or large holes in the main wheel perimeter weaken the structure of the main wheel perimeter; there are limitations on the length of spikes/spokes because long radial spikes tend to jam when retracted into the wheel; there are limitations on the shape of spikes/spokes (straight or tapered) that extend out in a radial manner; and there is discontinuity in frictional contact with the ground when the spikes/spokes are extended which can cause loss of control when the device is moving. The invention which I will disclose herein offers advantages over prior art in this sub-category because it does not have these limitations.

Although categorization of prior art can be imprecise, the following seem to be examples of prior art that can be best classified into sub-category #1a—wheels with spikes/spokes that can be extended outwards from the wheel into contact with the ground in radial manner through holes in the main wheel perimeter: U.S. Pat. No. 2,174,944 (Leggett, Nov. 16, 1937, “Vehicle Wheel Traction Means”); U.S. Pat. No. 2,250,713 (Johnson, Jul. 19, 1940, “Auxiliary Traction Device”); U.S. Pat. No. 2,924,486 (Blaschke, Aug. 13, 1956, Traction Increasing and Safety Device”); U.S. Pat. No. 3,239,277 (Beck, Mar. 4, 1964, “Traction Structure for Motor Vehicles”); U.S. Pat. No. 4,601,519 (Andrade et al., Jul. 22, 1986, “Wheel with Extendable Traction Spikes and Toy Including Same”); and U.S. Pat. No. 5,029,945 (Kidwell at al., Jul. 9, 1991, “Vehicular Traction Wheel”).

For devices in sub-category #1b: there are limitations on the number and width of spikes/spokes because numerous or large holes in the main wheel perimeter weaken the structure of the main wheel perimeter; there are limitations on the number of spikes/spokes because long spikes/spokes will overlap and jam when retracted into the wheel; and there is discontinuity in frictional contact with the ground when the spikes/spokes are extended which can cause loss of control when the device is moving. The invention which I will disclose herein offers advantages over prior art in this sub-category because it does not have these limitations.

Although categorization of prior art can be imprecise, the following seem to be examples of prior art that can be best classified into sub-category #1b—wheels with spikes/spokes that can be extended outwards from the wheel into contact with the ground in a non-radial angular manner, as with a spider wheel, through holes in the main wheel perimeter: U.S. Pat. No. 1,408,885 (Humphrey, Mar. 7, 1922, “Tractor Wheel”); U.S. Pat. No. 2,044,812 (Roessel, Jun. 8, 1935, “Antiskidding Device for Automobiles”); U.S. Pat. No. 2,818,301 (Hayden, Nov. 20, 1956, “Retractable Tractor Wheel Land Grips”); U.S. Pat. No. 4,266,832 (Delaunay et al., May 12, 1981, “Vehicle Wheel Anti-Slip Device”); U.S. Pat. No. 4,547,173 (Jaworski et al., Oct. 15, 1985, “Toy Vehicle Claw Wheel”); U.S. Pat. No. 4,643,696 (Law, Feb. 17, 1987, “Vehicle Wheel with Clutch Mechanism and Self Actuated Extending Claws”); U.S. Pat. No. 4,648,853 (Siegfried, Mar. 10, 1987, “Wheel Hub Locking Mechanism”); and U.S. Pat. No. 6,561,320 (Yi, May 13, 2003, “Automatically Operated Antiskid Apparatus For Automobile Tires”).

For devices in sub-category #1c: there are limitations on how narrow the combined wheel structure (including two parallel wheels) can be, which is problematic for applications for which wide tires (and wide turning radii) are not acceptable; there are gaps between the spikes/spokes, between the two wheels, which can become clogged with debris in all configurations; and there is discontinuity in frictional contact with the ground when the spikes/spokes are extended which can cause loss of control for the device. The invention which I will disclose herein offers advantages over prior art in this sub-category because it does not have these limitations.

Although categorization of prior art can be imprecise, the following seem to be examples of prior art that can be best classified into sub-category #1c—wheels with spikes/spokes that can be extended outwards from the wheel into contact with the ground in a radial manner through an opening between two parallel wheels: U.S. Pat. No. 5,788,335 (O'Brien, Aug. 4, 1998, “Traction Device for Vehicle Wheels”); U.S. Pat. No. 5,810,451 (O'Brien, Sep. 22, 1998, “Traction Device for Vehicle Wheels”); U.S. Pat. No. 6,022,082 (O'Brien, Feb. 8, 2000, “Traction Device for Vehicle Wheels”); U.S. Pat. No. 6,244,666 (O'Brien, Jun. 12, 2001, “Traction Device for Vehicle Wheels”); and U.S. Pat. No. 6,386,252 (O'Brien, May 14, 2002, “Traction Device for Vehicle Wheels”).

For devices in sub-category #1d: there are limitations on how narrow the combined wheel structure (including two parallel wheels) can be, which is problematic for applications for which wide tires (and wide turning radii) are not acceptable; there are limitations on the number of spikes/spokes because too many spikes/spokes will overlap and jam when retracted into the wheel; there are gaps between the spikes/spokes, between the two wheels, which can become clogged with debris in extended configurations; and there is discontinuity in frictional contact with the ground when the spikes/spokes are extended which can cause loss of control when the device is moving. The invention which I will disclose herein offers advantages over prior art in this sub-category because it does not have these limitations. Although categorization of prior art can be imprecise, the following seems to be an example of prior art that can be best classified into sub-category #1d—wheels with spikes/spokes that can be extended outwards from the wheel into contact with the ground in a non-radial angular manner, as with a spider wheel, through an opening between two parallel wheels: U.S. Pat. No. 8,007,341 (Su, Aug.30, 2011, “Wheel Assembly for Toy Car”).

For devices in sub-category #1e: there are limitations on how narrow the combined wheel structure (including the structure attached to the side of the wheel) can be, which is problematic for applications for which wide tires (and wide turning radii) are not acceptable; there are limitations on the number of spikes/spokes because too many spikes/spokes will overlap and jam when retracted into the wheel; and there is discontinuity in frictional contact with the ground when the spikes/spokes are extended which can cause loss of control when the device is moving. The invention which I will disclose herein offers advantages over prior art in this sub-category because it does not have these limitations.

Although categorization of prior art can be imprecise, the following seem to be examples of prior art that can be best classified into sub-category #1e—wheels with spikes/spokes that can be extended outwards from the wheel into contact with the ground in a radial manner from a mechanism on the side of a wheel: U.S. Pat. No. 1,319,018 (Oatsdean, Oct. 14, 1919, “Traction Device for Motor Vehicles”); U.S. Pat. No. 3,356,171 (Cichetti, Jun. 7, 1964, “Traction Assistance Device”); U.S. Pat. No. 3,458,236 (Winsen, Jul. 19, 1967, “Traction Increasing Wheel”); U.S. Pat. No. 4,193,466 (Arbderman, Mat. 18, 1980, “Traction-Enhancing Device for Automotive Vehicle Drive Wheels”); U.S. Pat. No. 4,909,576 (Zampieri, Mar. 20, 1990, “Antiskid Device for Motor Vehicles”); U.S. Pat. No. 7,380,618 (Gunderson et al., Jun. 3, 2088, “Stair Climbing Platform Apparatus and Method”); and U.S. Pat. No. 7,806,208 (Gunderson et al., Oct. 5, 2010, “Stair Climbing Platform Apparatus and Method”).

For devices in sub-category #1f: there are limitations on how narrow the combined wheel structure can be (including sufficient side space for lateral rotation of the spikes or other projections), which is problematic for applications for which wide tires (and wide turning radii) are not acceptable; and there is discontinuity in frictional contact with the ground when the spikes/spokes are extended which can cause loss of control when the device is moving. The invention which I will disclose herein offers advantages over prior art in this sub-category because it does not have these limitations.

Although categorization of prior art can be imprecise, the following seem to be examples of prior art that can be best classified into sub-category #1f—wheels with spikes or other projections that can be extended outwards from the wheel into contact with the ground in a laterally-rotating manner from a mechanism on the side of a wheel: U.S. Pat. No. 3,861,752 (Thurre at al., Jan. 21, 1975, “Anti-Skid Device for Wheeled Vehicles”); U.S. Pat. No. 4,120,336 (Baskall, Oct. 17, 1978, “Traction Device for Power Driven Vehicles”); U.S. Pat. No. 4,508,150 (Granryd, Apr. 2, 1985, “Retractable Traction Intensifying Means for Agricultural Tractors and the Like”); U.S. Pat. No. 4,603,916 (Granryd, Aug. 5, 1986, “Lightweight Retractable Track-Wheel for Agricultural Tractors and the Like”); U.S. Pat. No. 5,540,267 (Rona, Jul. 30, 1996, “Traction Device for Wheeled Vehicles”); U.S. Pat. No. 6,502,657 (Kerrebrock et al., Jan. 7, 2003, “Transformable Vehicle”); U.S. Pat. No. 6,860,346 (Burt et al., Mar. 1, 2005, “Adjustable Diameter Wheel Assembly and Methods and Vehicles Using Same”); U.S. Pat. No. 7,174,935 (Kahen, Feb. 13, 2007, “Automatic Safety Tire Device”); U.S. Pat. No. 7,217,170 (Moll et al., May 15, 2007, “Transformable Toy Vehicle”); U.S. Pat. No. 7,448,421 (Kahen, Nov. 11, 2008, “Safety Traction Device”); and U.S. Pat. No. 7,794,300 (Moll et al., Sep. 14, 2010, “Transformable Toy Vehicle”); and U.S. patent application 20040000439 (Burt et al., Jan. 1, 2004, “Adjustable Diameter Wheel Assembly, and Methods and Vehicles Using Same”).

For devices in sub-category #1g: there are limitations on how narrow the combined wheel structure can be (including the structure attached to the side of the wheel), which is problematic for applications for which wide tires (and wide turning radii) are not acceptable; there are gaps between the spikes/spokes which can become clogged with debris, and there is discontinuity in frictional contact with the ground when the spikes/spokes are extended which can cause loss of control when the device is moving. The invention which I will disclose herein offers advantages over prior art in this sub-category because it does not have these limitations.

Although categorization of prior art can be imprecise, the following seem to be examples of prior art that can be best classified into sub-category #1g—wheels with spikes/spokes that can be extended outwards from the wheel into contact with the ground in a non-radial angular manner, as with a spider wheel, from a mechanism on the side of a wheel: U.S. Pat. No. 3,995,909 (van der Lely, Dec. 7, 1976, “Vehicle Anti-Skid Mechanisms”); U.S. Pat. No. 4,906,051 (Vilhauer Jr., Mar. 6, 1990, “Easily Activated and Deactivated Traction Device for Vehicles”); U.S. Pat. No. 6,752,400 (Nakatsukasa et al., Jun. 22, 2004, “Moving Unit”); and U.S. Pat. No. 7,837,201 (Cheng et al., Nov. 23, 2010, “Assistant Apparatus for Surmounting Barrier”).

For devices in sub-category #1h: spikes/spokes without a main wheel perimeter cause a bumpy ride on flat, hard surfaces; and there are gaps between the spikes/spokes which can become clogged with debris. The invention which I will disclose herein offers advantages over prior art in this sub-category because it does not have these limitations. Although categorization of prior art can be imprecise, the following seem to be examples of prior art that can be best classified into sub-category #1h—wheels with spikes/spokes that can be extended outwards from the wheel into contact with the ground in a radial manner, unaccompanied by any main wheel perimeter: U.S. Pat. No. 6,402,161 (Baghdadi, Jun. 11, 2002, “Portable Stair-Climbing Load Transporting Dolly”); and U.S. Pat. No. 7,503,567 (Frankie, Mar. 17, 2009, “Automated Wheelchair”); and U.S. patent application 20080251300 (Frankie, Oct. 16, 2008, “Automated Wheelchair”).

2. Devices with Wheels with Differentially Inflatable/Deformable Perimeter Segments

The second category (#2) of relevant prior art includes devices with wheels with differentially inflatable/deformable perimeter segments. Differential inflation or deformation of different portions of a wheel's perimeter can change the shape of the wheel. This category includes devices with: (#2a) a tire with differential inflation of different perimeter segments; and (#2b) a tire with inner pistons or spokes that deform an elastic perimeter. I will now discuss the limitations of devices in these sub-categories.

For devices in sub-category #2a: there are constraints on how angular one can make a wheel perimeter based on differential inflation of perimeter segments. The resulting shapes are rounded and not well-suited for climbing stair treads or for traction on ice. Also, whenever segment inflation or deflation is required to change the shape of a wheel, there are limitations on how fast the shape can be changed in response to unexpected changes in surface conditions or obstacles. The invention which I will disclose herein offers advantages over prior art in this sub-category because it does not have these limitations. Although categorization of prior art can be imprecise, the following seems to be an example of prior art that can be best classified into sub-category #2a—a device with a tire with differential inflation of different perimeter segments: U.S. Pat. No. 6,725,895 (Tsipov, Apr. 27, 2004, “Wheel”).

For devices in sub-category #2b: there are constraints on how angular one can make a wheel perimeter based on deformation of a pneumatic (or other elastic) wheel perimeter using inner pistons or spokes. The resulting shapes are rounded and not well-suited for climbing stair treads or for traction on ice. Also, repeated deformation of a pneumatic (or other elastic) perimeter can cause material fatigue and structural failure. The invention which I will disclose herein offers advantages over prior art in this sub-category because it does not have these limitations. The invention which I will disclose herein offers advantages over prior art in this sub-category because it does not have these limitations.

Although categorization of prior art can be imprecise, the following seem to be examples of prior art that can be best classified into sub-category #2b—a device with a tire with inner pistons or spokes that deform an elastic perimeter: U.S. Pat. No. 5,407,054 (Matsuda et al., Apr. 18, 1995, “Roller of Variable Outer Diameter Type, and Carrying Apparatus and Method using the Same”); U.S. Pat. No. 5,480,022 (Matsuda et al., Jan. 2, 1996, “Roller of Variable Outer Diameter Type, and Carrying Apparatus and Method using the Same”); U.S. Pat. No. 5,839,795 (Matsuda et al., Nov. 24, 1998, “Variable Outer Diameter Wheel for Vehicles”); U.S. Pat. No. 6,264,283 (Rehkemper et al., Jul. 24, 2001, “Adjustable Wheel for Toy Vehicles”); U.S. Pat. No. 7,594,527 (Thompson, Sep. 29, 2009, “Wheel Cover System”); and U.S. Pat. No. 8,020,944 (Thompson, Sep. 20, 2011, “Wheel System with Deformable Tire”); and U.S. patent application 20110127732 (Mann et al., Jun. 2, 2011, “Stair Climbing Wheel with Multiple Configurations”).

3. Devices with Wheels with Differentially-Inflatable Parallel Adjacent Tires

The third category (#3) of relevant prior art includes devices with compound wheels that include two or more parallel, adjacent, and differentially-inflatable tires. Differential inflation of parallel tires with different traction characteristics can change which of the tires is in contact with the ground at a given time. When the different tires have different traction properties, this can provide changes in traction in response to different travel surfaces. For devices in category #3, the requirement of having multiple parallel adjacent tires means that this approach does not work for applications in which wide tires (and wide turning radii) are not acceptable. Also, for devices in category #3, there are constraints on how angular one can make a wheel perimeter. Tire shapes tend to be rounded and not well-suited for climbing stair treads or for traction on ice. Also, whenever segment inflation or deflation is required, there are limitations on how fast a device can change which tire contacts the ground in response to unexpected changes in surface conditions or obstacles. The invention which I will disclose herein offers advantages over prior art in this category because it does not have these limitations.

Although categorization of prior art can be imprecise, the following seem to be examples of prior art that can be best classified into category #3—two or more parallel and adjacent tires with differential inflation: U.S. Pat. No. 6,615,888 (Elkow, Sep. 9, 2003, “Variable-Diameter Wheel-and-Tire Apparatus for Motor Vehicles”); U.S. Pat. No. 6,637,834 (Elkow, Oct. 28, 2003, “Variable-Diameter Wheel Apparatus for Motor Vehicles”); and U.S. Pat. No. 6,733,088 (Elkow, May 11, 2004, “Variable-Diameter Wheel Apparatus for Motor Vehicles”).

4. Devices with Wheels with Foldable/Bendable Perimeter Segments

The fourth category (#4) of relevant prior art includes wheels with foldable or bendable perimeter segments. This category includes devices with: (#4a) wheels with perimeter segments that fold or bend inward; (#4b) wheels with perimeter segments that fold or bend outward; and (#4c) wheels with radial expansion of two or more perimeter segments outwards along a single mid-segment axis. I will now discuss the limitations of devices in these sub-categories.

Devices in sub-category #4a have perimeter segments that can become structurally weak due to repeated folding or bending. Also, for many devices in #4a, the process for restoring a perimeter to its pre-deformation (e.g. circular) shape is either a manual one or is not well specified. If a circular shape is automatically restored by outward pressure from elastic members in the wheel, then this outward pressure could cause undesirable loss of engagement with the travel surface. For example, a circular wheel that becomes non-circular in response to encountering a staircase due to deformation of an elastic member within the wheel could “pop out” again into circular shape when the device is mid-way up the staircase, with dire consequences for the person being transported. The invention which I will disclose herein offers advantages over prior art in this sub-category because it does not have these limitations. Although categorization of prior art can be imprecise, the following seem to be examples of prior art that can be best classified into sub-category #4a—wheel with perimeter segments that fold or bend inward: U.S. Pat. No. 3,179,431 (Pikl, Jan. 29, 1963, “Obstacle-Climbing Wheel Chairs”); and U.S. Pat. No. 3,226,129 (McKinley, Nov. 4, 1963, “Vehicle and. Deformable Wheel Thereof”); and U.S. patent application 20010030402 (White, Oct. 18, 2001, “All-Terrain Wheeled Vehicle”).

Devices in sub-category #4b have perimeter segments that can become structurally weak or fail due to repeated folding or bending. Also, for some devices in #4b, the process for restoring a perimeter to its pre-deformation (e.g. circular) shape is not well specified. If a circular shape is automatically restored by, inward pressure from a travel surface on elastic members, then this inward pressure could cause undesirable loss of engagement with the travel surface. For example, a wheel that becomes non-circular in response to encountering a staircase could “pop inwards” again into a circular shape when the device is mid-way up the staircase, with dire consequences for the person being transported. Also, in #4b devices there are gaps between segments of the wheel perimeter that fold or bend outwards. These gaps may become clogged with debris and prevent the wheel from returning to a circular configuration. The invention which I will disclose herein offers advantages over prior art in this sub-category because it does not have these limitations. Although categorization of prior art can be imprecise, the following seem to be examples of prior art that can be best classified into sub-category #4b—wheel with perimeter segments that fold or bend outward: U.S. Pat. No. 4,773,889. (Rosenwinkel et al., Sep. 27, 1988, “Wheel for a Toy Vehicle”); and U.S. Pat. No. 5,487,692 (Mowrer et al., Jan. 30, 1996, “Expandable Wheel Assembly”).

Devices in sub-category #4c have gaps between segments of the wheel perimeter that extend radially outwards along a single mid-segment axis. These gaps may become clogged with debris and prevent the wheel from returning to a circular configuration. There are also constraints on the shapes that such radial extension can create. For example, radial extension of two halves of a wheel creates an overall oblong shape. Radial extension of three thirds of a wheel creates a rounded triangular shape. These rounded shapes may not offer the variation in shape configuration that is required to climb up or over various obstacles, such as a staircase. The invention which I will disclose herein offers advantages over prior art in this sub-category because it does not have these limitations. Although categorization of prior art can be imprecise, the following seems to be an example of prior art that can be best classified into sub-category #4c—wheel with radial expansion of perimeter segments outwards along a single mid-segment axis: U.S. Pat. No. 5,102,367 (Mullaney et al., Apr. 7, 1992, “Toy Vehicle Wheel and Axle Assembly”).

5. Devices with Wheels with Differentially-Expandable Concentric Rings

The fifth category (#5) of relevant prior art includes devices with a wheel with differentially-expandable (e.g. inflatable) concentric rings. For example, there can be an inner tire with an uneven perimeter and an outer inflatable ring with a smooth perimeter around that inner tire. When the outer ring is inflated, then the wheel has a smooth outer perimeter. When the outer ring is deflated, it collapses onto the inner tire and the wheel has an uneven outer perimeter. Devices in category #5 have limitations. For example, the impact of the inner tire surface is limited because it is dampened by the surface of the deflated outer ring when the outer ring is deflated. Also, there are limits to how quickly the outer ring can be deflated in response to unexpected changes in the surface or obstacles that the device encounters. Also, the inner surface, which would be used to provide greater traction, is smaller in diameter than the outer ring, which is counter-productive for traction. The invention which I will disclose herein offers advantages over prior art in this category because it does not have these limitations. Although categorization of prior art can be imprecise, the following seems to be an example of prior art that can be best classified into category #5—device with a wheel with differentially-expandable concentric rings: U.S. Pat. No. 4,919,489 (Kopsco, Apr. 24, 1990, “Cog-Augmented Wheel for Obstacle Negotiation”).

6. Devices with Compound Wheels or Multiple Interacting Circular Wheels

The sixth category (#6) of relevant prior art includes devices with composite wheels (such as rotating configurations of multiple wheels) or multiple interacting circular wheels. Such wheel configurations can enhance a device's surface traveling or obstacle-climbing ability. Devices in category #6 are generally, perhaps even universally in the prior art, comprised of multiple circular wheels. Circular wheels do not provide the angular shapes that are needed for traction on surfaces such as ice or snow, even when they are used in multi-wheel configurations. Devices in #6 have limited grasping and hooking ability for climbing up, or over, obstacles. Also, devices in #6 do not provide the simplicity, speed, and smooth ride of a single large wheel for traveling on flat, hard surfaces. The invention which I will disclose herein offers advantages over prior art in this category because it does not have these limitations.

Although categorization of prior art can be imprecise, the following seem to be examples of prior art that can be best classified into category #6—devices with composite wheels (such as rotating configurations of multiple wheels) or multiple interacting circular wheels: U.S. Pat. No. 4,512,588 (Cox, Apr. 23, 1985, “Stair Climbing Wheel Chair”); U.S. Pat. No. 4,674,757 (Martin, Jun. 23, 1987, “Stair-Climbing Wheel Utilizing an Involute Curve Configuration”); U.S. Pat. No. 4,709,772 (Brunet, Dec. 1, 1987, “Motorized Moving Device”); U.S. Pat. No. 4,790,548 (Decelles et al., Dec. 13, 1998, “Climbing and Descending Vehicle”); U.S. Pat. No. 4,993,912 (King et al., Feb. 19, 1991, “Stair Climbing Robot”); U.S. Pat. No. 5,273,296 (Lepek, Dec. 28, 1993, “Obstacle Overcoming Vehicle Suspension System”); U.S. Pat. No. 5,701,965 (Kamen et al., Dec. 30, 1997, “Human Transporter”); U.S. Pat. No. 5,964,473 (Degonda et al., Oct. 12, 1999, “Wheelchair for Transporting or Assisting the Displacement of at Least One User Particularly for Handicapped Person”); U.S. Pat. No. 5,971,091 (Kamen et al., Oct. 26, 1999, “Transportation Vehicles and Methods”); U.S. Pat. No. 6,311,794 (Morrell et al., Nov. 6, 2001, “System and Method for Stair Climbing in a Cluster-Wheel Vehicle”); U.S. Pat. No. 6,343,664 (Morrell et al., Feb. 5, 2002, “Operating Modes for Stair Climbing in a Cluster-Wheel Vehicle”); U.S. Pat. No. 6,443,251 (Morrell et al., Sep. 3, 2002, “Methods for Stair Climbing in a Cluster-Wheel Vehicle”); U.S. Pat. No. 6,484,829 (Cox, Nov. 26, 2002, “Battery Powered Stair-Climbing Wheelchair”); U.S. Pat. No. 6,615,938 (Morrell et al., Sep. 9, 2003, “Mechanism for Stair Climbing in a Cluster-Wheel Vehicle”); U.S. Pat. No. 6,799,649 (Kamen et al., Oct. 5, 2004, “Control of a Balancing Personal Vehicle”); U.S. Pat. No. 7,040,429 (Molnar, May 9, 2006, “Wheelchair Suspension”); U.S. Pat. No. 7,055,634 (Molnar, Jun. 6, 2006, “Wheelchair suspension”); U.S. Pat. No. 7,066,290 (Fought, Jun. 27, 2006, “Wheelchair Suspension Having Pivotal Motor Mount”); U.S. Pat. No. 7,219,755 (Goertzen et al., May 22, 2007, “Obstacle Traversing Wheelchair”); U.S. Pat. No. 7,374,002 (Fought, May 20, 2008, “Wheelchair Suspension”); U.S. Pat. No. 7,426,970 (Olsen, Sep. 23, 2008, “Articulated Wheel Assemblies and Vehicles Therewith”); and U.S. Pat. No. 7,784,569 (Cheng et al., Aug. 31, 2010, “Barrier-Overpassing Transporter”); and U.S. patent application 20070152427 (Olsen, Jul. 5, 2007, “Articulated Wheel Assemblies and Vehicles Therewith”).

7. Devices with Multiple Interacting Non-Circular Wheels

The seventh category (#7) of relevant prior art includes devices with multiple non-circular interacting wheels that function in series or in parallel. Wheels that function in series rotate around sequential axes. Wheels that function in rotate around the same axis. Multiple non-circular wheels can function as non-circular wheels when they rotate in a synchronized manner, but can collectively mimic circular wheels when they rotate in an asynchronous manner. This category includes devices with: (#7a) multiple interacting non-circular wheels that are configured in series; and (#7b) multiple interacting non-circular wheels that are configured in parallel. I will now discuss the limitations of devices in these sub-categories in detail.

Devices in sub-category #7a do not provide the simplicity, speed, and smooth ride of a single large wheel when traveling on flat, hard surfaces. Also, devices in sub-category #7a require multiple wheels. This increases the weight of the device and limits its turning radius. The invention which I will disclose herein offers advantages over prior art in this sub-category because it does not have these limitations. Although categorization of prior art can be imprecise, the following seems to be an example of prior art that can be best classified into sub-category #7a—devices with multiple interacting non-circular wheels that are configured in series: U.S. Pat. No. 6,604,589 (Sepitka, Aug. 12, 2003, “Drive for a Vehicle Intended to Transverse Rough Terrain”).

Devices in sub-category #7b do not provide the simplicity, speed, and smooth ride of a single large wheel when traveling on flat, hard surfaces. Devices in sub-category #7b also require multiple parallel adjacent wheels. This is not feasible for applications that cannot accommodate wide wheels. The invention which I will disclose herein offers advantages over the prior art because it does not have these limitations. Although categorization of prior art can be imprecise, the following seem to be examples of prior art that can be best classified into sub-category #7b—devices with multiple interacting non-circular wheels that are configured in parallel: U.S. Pat. No. 5,971,091 (Kamen et al., Oct. 26, 1999, “Transportation Vehicles and Methods”); and U.S. Pat. No. 7,749,033 (Paulus, Jul. 6, 2010, “Amphibious Surface Vehicle with Synchro-Phased Rotary Engagement Devices”); and U.S. patent application 20100159757 (Paulus, Jun. 24, 2010, “Amphibious Surface Vehicle with Synchro-Phased Rotary Engagement Devices”).

8. Devices with Endless-Loop Tracks

The eighth category (#8) of relevant prior art includes devices with an “endless-loop” track that goes around two or more inner wheels, like the endless-loop tracks used in military tanks. This category includes: (#8a) devices with only an endless-loop track that goes around two or more inner wheels whose positions are fixed relative to each other; (#8b) devices with only an endless-loop track that goes around two or more inner wheels whose positions can be moved relative to each other; (#8c) devices with simultaneous operation of both an endless-loop track and surface-contacting wheels; and (#8d) devices with adjustable selection of either an endless-loop track or surface-contacting wheels. I will now discuss the limitations of devices in these sub-categories in detail.

Sub-category #8a devices tend to be heavy due to the multiple inner wheels and the weight of the track. Heavy devices consume more energy, deplete battery life, are dangerous to the person if they tip over, and are difficult to move in the event of motor failure or battery failure. Also, for sub-category #8a devices it is difficult to create tracks with projections that are sufficiently long and stiff to provide safe and secure engagement with step treads for climbing staircases. Track projections on such devices tend to be short and/or flexible, which can be insufficient to safely grasp stairs. If the heavy device slips, it can topple down the stairs and crush the person being transported. Also, sub-category #8a devices do not provide a large circular wheel for smooth, rapid travel over a flat, hard surface. A fourth problem is that such devices have a relatively wide turning radius, making them difficult to maneuver in indoor settings such as an office or store. Finally, some people may not like the “tank-like” appearance of such devices. The invention which I will disclose herein offers advantages over prior art in this sub-category because it does not have these limitations.

Although categorization of prior art can be imprecise, the following seem to be examples of prior art that can be best classified into sub-category #8a—devices with only an endless-loop track that goes around two or more inner wheels whose positions are fixed relative to each other: U.S. Pat. No. 3,869,011 (Jensen, Mar. 4, 1975, “Stair Climbing. Tracked Vehicle”); U.S. Pat. No. 4,077,483 (Randolph, Mar. 7, 1978, “Invalid Vehicle”); U.S. Pat. No. 5,123,495 (Littlejohn et al., Jun. 23, 1992, “Wheelchair Stair Climbing Control System”); U.S. Pat. No. 5,248,007 (Watkins et al., Sep. 28, 1993, “Electronic Control System for Stair Climbing Vehicle”); U.S. Pat. No. 5,577,567 (Johnson et al., Nov. 26, 1996, “Stair Climbing Wheelchair”); U.S. Pat. No. 5,676,215 (Misawa, Oct. 14, 1997, “Stair-Climbing Crawler Transporter”); U.S. Pat. No. 6,250,409 (Wells, Jun. 26, 2001, “Multi-Point Mobility Device”); U.S. Pat. No. 6,604,590 (Foulk Jr., Aug. 12, 2003, “Battery Powered All-Terrain Vehicle for the Physically Challenged”); and U.S. Pat. No. 6,619,414 (Rau, Sep. 16, 2003, “Personal Mobility Vehicle”); and U.S. patent application 20110011652 (Swensen, Jan. 20, 2011, “Multi-Terrain Motorized Wheelchair Apparatus”).

Sub-category #8b devices also tend to be heavy due to the multiple inner wheels and the weight of the track. Also, sub-category #8a devices do not provide a large circular wheel for smooth, rapid travel over a flat, hard surface. Also, they have a relatively wide turning radius, making them difficult to maneuver in indoor settings. Further, for devices in sub-category #8b, it is difficult to create an endless-loop track that can vary in length without mechanical failures and breakage. If one makes an endless-loop track that can stretch, then it can slip on the gear mechanisms that drive it and can suffer material fatigue and breakage. If one makes an endless-loop track that cannot stretch, then one needs a mechanism for storing slack and maintaining tension in smaller-perimeter configurations. Such storage mechanisms can be complex and, if they involve a combination of convex and concave loops, can easily be clogged by debris on the track. The invention which I will disclose herein offers advantages over prior art in this sub-category because it does not have these limitations.

Although categorization of prior art can be imprecise, the following seem to be examples of prior art that can be best classified into sub-category #8b—devices with only an endless-loop track that goes around two or more inner wheels whose positions can be moved relative to each other: U.S. Pat. No. 3,459,454 (Liston, Aug. 7, 1967, “Elliptical Wheel”); U.S. Pat. No. 3,712,359 (Williams, Jan. 23, 1973, “Crazy Tires”); U.S. Pat. No. 3,802,743 (Hermanns, Apr. 9, 1974, “Variable Diameter Wheel”); U.S. Pat. No. 4,046,339 (Stancliffe, Sep. 6, 1977, “Landing Gear for an Aircraft Including Expansible Wheels”); U.S. Pat. No. 4,194,584 (Kress et al., Mar. 25, 1980, “Variable. Terrain Vehicle”); U.S. Pat. No. 5,423,563 (Wild, Jun. 13, 1995, “Wheelchair Having Apparatus for Climbing Stairs”); U.S. Pat. No. 5,492,390 (Kugelmann Sr., Feb. 20, 1996, “Variable Shaped Wheel”); U.S. Pat. No. 6,422,576 (Michaeli et al., Jul. 23, 2002, “Transport Mechanism”); U.S. Pat. No. 7,334,850 (Spector et al., Feb. 26, 2008, “Adaptable Traction System of a Vehicle”); and U.S. Pat. No. 7,547,078 (Spector et al., Jun. 16, 2009, “Adaptable Traction System of a Vehicle”); and U.S. patent applications 20050127752 (Spector et al., Jun. 16, 2005, “Adaptable Traction System of a Vehicle”); 20080061627 (Spector et al., Mar. 13, 2008, “Adaptable Traction System of a Vehicle”); and 20090212623 (Spector et al., Aug. 27, 2009, “Adaptable Traction System of a Vehicle”).

Sub-category #8c devices also tend to be heavy because not only do they have the multiple inner wheels and a track, but they have regular wheels as well. Also, for sub-category #8c devices it is difficult to create tracks with projections that are sufficiently long and stiff to provide safe and secure engagement with step treads for climbing staircases. Track projections on such devices tend to be short and/or flexible, which can be insufficient to safely grasp stairs. If the heavy device slips, it can topple down the stairs and crush the person being transported. Also, sub-category #8c devices do not provide a circular wheel for smooth, rapid travel over a flat, hard surface. The invention which I will disclose herein offers advantages over prior art in this sub-category because it does not have these limitations. Although categorization of prior art can be imprecise, the following seem to be examples of prior art that can be best classified into sub-category #8c—devices with simultaneous operation of both an endless-loop track and surface-contacting wheels: U.S. Pat. No. 4,898,256 (Lehner, Feb.6, 1990, “Stair-Climbing Wheelchair Carrier with Crawlers”); U.S. Pat. No. 5,395,129 (Kao, Mar. 7, 1995, “Wheel Chair”); and U.S. Pat. No. 7,597,163 (Goertzen et al., Oct. 6, 2009, “Obstacle Traversing Wheelchair”).

Sub-category #8d devices also tend to be heavy because not only do they have the multiple inner wheels and a track, but they have regular wheels as well. Also, for sub-category #8d devices it is difficult to create tracks with projections that are sufficiently long and stiff to provide safe and secure engagement with step treads for climbing staircases. Track projections on such devices tend to be short and/or flexible, which can be insufficient to safely grasp stairs. Further, there are limitations on how quickly such a device can be transitioned from endless-loop track to wheels, or vice versa, in response to unexpected changes in the type of travel surface or surface obstacles. The invention which I will disclose herein offers advantages over prior art in this sub-category because it does not have these limitations.

Although categorization of prior art can be imprecise, the following seem to be examples of prior art that can be best classified into sub-category #8d—devices with adjustable selection of either an endless-loop track or surface-contacting wheels: U.S. Pat. No. 4,044,850 (Winsor, Aug. 30, 1977, “Wheelchair”); U.S. Pat. No. 4,119,163 (Ball, Oct. 10, 1978, “Curb Climbing Wheel Chair”); U.S. Pat. No. 4,432,425 (Nitzberg, Feb. 21, 1984, “Wheel Chair”); U.S. Pat. No. 4,566,551 (Feliz, Jan. 28, 1986, “Stair-Climbing Conveyance”); U.S. Pat. No. 4,566,707 (Nitzberg, Jan. 28, 1986, “Wheel Chair”); U.S. Pat. No. 4,674,584 (Watkins, Jun. 23, 1987, “Stair-Climbing Wheelchair with Stair Step Sensing Means”); U.S. Pat. No. 4,687,068 (Pagett, Aug. 18, 1987, “Invalid's Wheelchair and Like Conveyances”); U.S. Pat. No. 4,962,941 (Rembos, Oct. 16, 1990, “Wheelchair Apparatus”); U.S. Pat. No. 5,335,741 (Rabinovitz et al., Aug. 9, 1994, “Externally Mounted Track Apparatus for a Wheel Chair”); U.S. Pat. No. 5,423,563 (Wild, Jun. 13, 1995, “Wheelchair Having Apparatus for Climbing Stairs”); U.S. Pat. No. 5,868,403 (Culp et al., Feb. 9, 1999, “Medical Transport Device”); U.S. Pat. No. 6,076,619 (Hammer, Jun. 20, 2000, “All Terrain Vehicle for Disabled Persons”); U.S. Pat. No. 6,336,642 (Carstens, Jan. 8, 2002, “Safety Device for Stair-Climbing Systems”); U.S. Pat. No. 6,341,784 (Carstens, Jan. 29, 2002, “Motor-Driven Stair Climbing Device”); U.S. Pat. No. 6,805,209 (Hedeen, Oct. 19, 2004, “Wheelchair Motorizing Apparatus”); U.S. Pat. No. 6,857,490 (Quigg, Feb. 22, 2005, “Stair-Climbing Wheelchair”); U.S. Pat. No. 7,316,405 (Kritman et al., Jan. 8, 2008, “Stair-Climbing Apparatus”); and U.S. Pat. No. 7,384,046 (LeMasne De Chermont, Jun. 10, 2008, “Powered Wheeled Vehicle Capable of Travelling on Level Ground over Uneven Surfaces and on Stairs”); and U.S. patent applications 20030116927 (Quigg, Jun. 26, 2003, “Stair-Climbing Wheelchair”); 20030183428 (Hedeen, Oct. 2, 2003, “Wheelchair Motorizing Apparatus”); 20090230638 (Reed et al., Sep. 17, 2009, “Stair Chair”); and 20110031045 (Underwood, Feb. 10, 2009, “Tracked Mobility Device”).

9. Devices with Walking Legs

The ninth category (#9) of relevant prior art includes devices with legs for walking. This category includes: (#9a) devices with walking legs and no wheels; (#9b) devices with both walking legs and wheels; and (#9c) hybrid leg/wheel devices that have legs and no wheels, but wherein the legs interact together to function like one or more virtual circular wheels. I will now discuss the limitations of devices in these sub-categories in detail.

Future devices in sub-category #9a may prove to be the ultimate substitute for natural human bipedal movement. After all, humans normally travel by walking and most human-made environments are designed for walking. Artificial walking devices may someday provide the best means of traveling in human-made environments. However, walking technology, particularly bipedal walking technology, has not yet reached this level of performance. Most devices in this category have at least four legs. The resulting devices often look like giant robotic insects—not very appealing to most people. Also, devices in sub-category #9a do not provide a circular wheel for rapid, smooth transportation over flat, hard surfaces. Further, such devices tend to have a larger footprint and turning radius than wheeled devices. This can cause problems in constrained indoor environments. The invention which I will disclose herein offers advantages over prior art in this sub-category because it does not have these limitations.

Although categorization of prior art can be imprecise, the following seem to be examples of prior art that can be best classified into sub-category #9a—devices with walking legs and no wheels: U.S. Pat. No. 6,364,040 (Klann, Apr. 2, 2002, “Walking Device”); U.S. Pat. No. 6,478,314 (Klann, Nov. 12, 2002, “Walking Device”); U.S. Pat. No. 6,805,677 (Simmons, Oct. 19, 2004, “Wheel-Less Walking Support and Rehabilitation Device”); and U.S. Pat. No. 7,918,808 (Simmons, Apr. 5, 2011, “Assistive Clothing”); and U.S. patent applications 20030120183 (Simmons, Jun. 26, 2003, “Assistive Clothing”); and 20030191507 (Simmons, Oct. 9, 2003, “Wheel-Less Walking Support and Rehabilitation Device”).

Devices in sub-category #9b can be cumbersome because it can be difficult to combine legs and wheels in a single device. Also, devices in sub-category #9b do not offer the simplicity of a large circular wheel for rapid, smooth transportation over flat, hard surfaces. Further, devices in sub-category #9b cannot respond quickly to surface changes because of the time lag required to transition for legs to wheels, or vice versa. The invention which I will disclose herein offers advantages over prior art in this sub-category because it does not have these limitations. Although categorization of prior art can be imprecise, the following seem to be examples of prior art that can be best classified into sub-category #9b—devices with both legs and wheels: U.S. Pat. No. 4,265,326 (Lauber, May 5, 1981, “Rolling and Stepping Vehicle”); U.S. Pat. No. 5,513,716 (Kumar, May 7, 1996, “Adaptive Mobility System”); U.S. Pat. No. 6,328,120 (Haussler et al., Dec. 11, 2001, “Stair Climbing Vehicle”); U.S. Pat. No. 6,484,829 (Cox, Nov. 26, 2002, “Battery Powered Stair-Climbing Wheelchair”); U.S. Pat. No. 6,554,086 (Goertzen et al., Apr. 29, 2003, “Obstacle Traversing Wheelchair”); U.S. Pat. No. 6,923,280 (Goertzen et al., Aug. 2, 2005, “Obstacle Traversing Wheelchair”); U.S. Pat. No. 6,935,448 (Goertzen et al., Aug. 30, 2005, “Obstacle Traversing Wheelchair”); and U.S. Pat. No. 7,950,673 (Reed et al., May 31, 2011, “Stair Chair”); and U.S. patent application 20100013172 (Goertzen et al., Jan. 21, 2010, “Obstacle Traversing Wheelchair”).

Devices in sub-category #9c are novel and innovative, but they also have limitations. For example, devices in sub-category #9c do not offer the simplicity of a large circular wheel for rapid, smooth transportation over flat, hard surfaces. Also, sub-category #9c devices in the prior art do not appear to provide stair-climbing ability. Sub-category #9c devices also require complex (variable speed) and coordinated movement of arcuate legs in order to create a virtual circular wheel. While such complex movement may be possible on flat, hard surfaces, it may be challenging to operationalize when climbing obstacles or traversing staircases. The invention which I will disclose herein offers advantages over prior art in this sub-category because it does not have these limitations. Although categorization of prior art can be imprecise, the following seem to be examples of prior art that can be best classified into sub-category #9c—“hybrid leg/wheel devices that have legs and no wheels, but wherein the legs interact to function like one or more wheels: U.S. Pat. No. 7,017,687 (Jacobsen et al., Mar. 28, 2006, “Reconfigurable Articulated Leg and Wheel”); U.S. Pat. No. 7,543,663 (Setrakian et al., Jun. 9, 2009, “Bimodal Conveyance Mechanism”); U.S. Pat. No. 7,588,105 (Hillis et al., Sep. 15, 2009, “Virtual-Wheeled Vehicle”); U.S. Pat. No. 7,753,145 (Hillis et al., Jul. 13, 2010, “Virtual-Wheeled Vehicle”); and U.S. Pat. No. 7,836,983 (Setrakian et al., Nov. 23, 2010, “Bimodal Conveyance Mechanism”); and U.S. patent applications 20060076167 (Setrakian et al., Apr. 13, 2006, “Bimodal Conveyance Mechanism”); 20070227786 (Hillis et al., Oct. 4, 2007, “Virtual-Wheeled Vehicle”); 20080262661 (Setrakian et al., Oct. 23, 2008, “Bimodal Conveyance Mechanism”); 20090038863 (Hillis et al., Feb. 12, 2009, “Virtual-Wheeled Vehicle”); and 20100090426 (Setrakian et al., Apr. 15, 2010, “Bimodal Conveyance Mechanism”).

### 10. Unclassified Devices in the Prior Art

There are also devices in the prior art that seem to be generally relevant to the field of this invention, but which I was not able to classify into one of the above categories. This unclassified prior art includes the following: U.S. Pat. No. 4,355,451 (Thomas, Oct. 26, 1982, “Retractable Device and Method for Providing Traction”); U.S. Pat. No. 4,643,251 (Ziccardi et al., Feb. 17, 1987, “Traction Devices for Automotive Wheels”); U.S. Pat. No. 4,823,900 (Farnam, Apr. 25, 1989, “Four-Wheel Drive Wheel-Chair with Compound Wheels”); U.S. Pat. No. 4,913,685 (Lukatsch, Apr. 3, 1990, “Wheel with Variable Diameter”); U.S. Pat. No. 4,926,952 (Farnam, May 22, 1990, “Four-Wheel Drive Wheelchair with Compound Wheels”); U.S. Pat. No. 5,323,867 (Griffin et al., Jun. 28, 1994, “Robot Transport Platform with Multi-Directional Wheels”); U.S. Pat. No. 5,413,367 (Ochiai, May 9, 1995, “Movable Chair”); U.S. Pat. No. 5,507,513 (Peters et al., Apr. 16, 1996, “Multi-Terrain Wheelchair”); U.S. Pat. No. 5,690,375 (Schneider, Nov. 25, 1997, “Ezekiel's Wheel”); U.S. Pat. No. 5,842,532 (Fox et al., Dec. 1, 1998, “Personal Transport Vehicle and Method of Improving the Maneuverability of a Vehicle”); U.S. Pat. No. 5,983,452 (McGovern, Nov. 16, 1999, “Wheel Skid”); U.S. Pat. No. 6,003,624 (Jorgensen et al., Dec. 21, 1999, “Stabilizing Wheeled Passenger Carrier Capable of Traversing Stairs”); U.S. Pat. No. 6,073,958 (Gagnon, Jun. 13, 2000, “All Terrain Wheelchair”); U.S. Pat. No. 6,241,321 (Gagnon, Jun. 5, 2001, “All Terrain Wheel for a Wheelchair”); U.S. Pat. No. 6,276,703 (Caldwell, Aug. 21, 2001, “Land Rower”); U.S. Pat. No. 6,279,631 (Tuggle, Aug. 28, 2001, “Low Pressure Tire”); U.S. Pat. No. 6,367,817 (Kamen et al., Apr. 9, 2002, “Personal Mobility Vehicles and Methods”); U.S. Pat. No. 6,419,036 (Miglia, Jul. 16, 2002, “Vehicle for Wheel Chairs”); U.S. Pat. No. 6,538,411 (Field et al., Mar. 25, 2003, “Deceleration Control of a Personal Transporter”); U.S. Pat. No. 6,547,340 (Harris, Apr. 15, 2003, “Low Vibration Omni-Directional Wheel”); and U.S. Pat. No. 6,557,879 (Caldwell, May 6, 2003, “Land Rower”).

Uncategorized relevant prior art also includes U.S. Pat. No. 6,571,892 (Kamen et al., Jun. 3, 2003, “Control System and Method”); U.S. Pat. No. 6,581,714 (Kamen et al., Jun. 24, 2003, “Steering Control of a Personal Transporter”); U.S. Pat. No. 6,651,766 (Kamen et al., Nov. 25, 2003, “Personal Mobility Vehicles and Methods”); U.S. Pat. No. 6,715,780 (Schaeffer et al., Apr. 6, 2004, “Wheelchair”); U.S. Pat. No. 6,796,396 (Kamen et al., Sep. 28, 2004, “Personal Transporter”); U.S. Pat. No. 6,796,618 (Harris, Sep. 28, 2004, “Method for Designing Low Vibration Omni-Directional Wheels”); U.S. Pat. No. 6,815,919 (Field et al., Nov. 9, 2004, “Accelerated Startup for a Balancing Personal Vehicle”); U.S. Pat. No. 7,004,271 (Kamen et al., Feb. 28, 2006, “Dynamic Balancing Vehicle with a Seat”); U.S. Pat. No. 7,231,948 (Forney, Jun. 19, 2007, “Non-Pneumatic Tire”); U.S. Pat. No. 7,246,671 (Goren et al., Jul. 24, 2007, “Stair-Climbing Human Transporter”); U.S. Pat. No. 7,275,607 (Kamen et al., Oct. 2, 2007, “Control of a Personal Transporter Based on User Position”); U.S. Pat. No. 7,370,713 (Kamen, May 13, 2008, “Personal Mobility Vehicles and Methods”); U.S. Pat. No. 7,472,767 (Molnar, Jan. 6, 2009, “Wheelchair Suspension”); U.S. Pat. No. 7,562,728 (Voigt, Jul. 21, 2009, “Powered Wheelchair”); U.S. Pat. No. 7,648,156 (Johanson, Jan. 19, 2010, “Dual Mode Wheelchair”); U.S. Pat. No. 7,669,679 (Rastegar et al., Mar. 2, 2010, “Wheel Assembly for Decelerating and/or Controlling a Vehicle”); U.S. Pat. No. 7,690,447 (Kamen et al., Apr. 6, 2010, “Dynamic Balancing Vehicle with a Seat”); U.S. Pat. No. 7,690,452 (Kamen et al., Apr. 6, 2010, “Vehicle Control by Pitch Modulation”); U.S. Pat. No. 7,757,794 (Heinzmann et al., Jul. 20, 2010, “Vehicle Control by Pitch Modulation”); U.S. Pat. No. 7,761,954 (Ziegler et al., Jul. 27, 2010, “Autonomous Surface Cleaning Robot for Wet and Dry Cleaning”); U.S. Pat. No. 7,900,725 (Heinzmann et al., Mar. 8, 2011, “Vehicle Control by Pitch Modulation”); U.S. Pat. No. 7,900,945 (Rackley, Mar. 8, 2011, “All-Terrain Wheelchair”); U.S. Pat. No. 7,982,423 (Skaff, Jul. 19, 2011, “Statically Stable Biped Robotic Mechanism and Method of Actuating”); U.S. Pat. No. 8,002,294 (Brandeau, Aug. 23, 2011, “Vehicle Wheel Assembly with a Mechanism Compensating for a Varying Wheel Radius”); and U.S. Pat. No. 8,014,923 (Ishii et al., Sep. 6, 2011, “Travel Device”). Uncategorized relevant prior art also includes U.S. patent applications: 20060144494 (Tuggle, Jul. 6, 2006, “Low Pressure Tire”); 20060260857 (Kakinuma et al., Nov. 23, 2006, “Coaxial Two-Wheel Vehicle”); 20080295595 (Tacklind et al., Dec. 4, 2008, “Dynamically Balanced In-Line Wheel Vehicle”); 20090044990 (Lexen, Feb. 19, 2009, “Screw Driven Mobile Base”); 20090166996 (Spindle, Jul. 2, 2009, “Wheelchairs and Wheeled Vehicles Devices”); 20100102529 (Lindenkamp et al., Apr. 29, 2010, “Wheelchair with Suspension Arms for Wheels”); 20110050883 (Ghose et al., Mar. 3, 2011, “Machine Vision Based Obstacle Avoidance System”); 20110083915 (Nelson et al., Apr. 14, 2011,“Adjustable Mid-Wheel Power Wheelchair Drive System”); 20110175320 (Johnson et al., Jul. 21, 2011, “Stabilized Mobile Unit or Wheelchair”); and 20110204592 (Johansen et al., Aug. 25, 2011, “Mobility and Accessibility Device and Lift”).

### SUMMARY AND ADVANTAGES OF THIS INVENTION

This present invention is a motorized personal mobility device with shape-changing wheels for transporting a person over different surfaces and obstacles. This invention comprises novel technology that can be used to create next-generation motorized wheelchairs that can enable people who cannot walk independently to travel over ice and snow, to go “off-road” in rustic areas, and to travel up (and down) staircases by themselves. This invention includes: (1) a support structure that supports the person who is being transported; (2) a motor that moves the support structure by rotating at least one surface-contacting wheel, wherein the device travels on this surface; and (3) at least one shape-changing wheel that changes shape to travel more effectively on different surfaces and obstacles.

The shape of the shape-changing wheel is changed by the motorized rotation of at least two rotating members that are part of the shape-changing wheel. This rotation can be independent of the rotation of the wheel as a whole. Rotation of these rotating members into a first configuration causes the ground (or other travel surface) contacting perimeter of the wheel to be a first shape that is substantively circular. Rotation of these rotating members into a second configuration causes the ground (or other travel surface) contacting perimeter of the wheel to be a second shape that is non-circular.

More effective travel is achieved by one or more means selected from the group consisting of: more grasping, hooking, or other engagement of a substantially level, but slippery, surface in order to provide better traction on that surface; more reaching, stepping, or climbing over an obstacle on an otherwise substantially level surface; more grasping, hooking, or other engagement of a higher surface in order to pull the device upwards onto that higher surface, such as more grasping, hooking, or other engagement of successive stair treads to pull the device up a flight of stairs; more grasping, hooking, or other engagement of a lower surface to controllably lower the device downwards onto that lower surface, such as more grasping, hooking, or other engagement of successive stair treads to controllably lower the device down a flight of stairs; and differential changes in the shapes of two or more shape-changing wheels in order to help prevent the device from tipping over when traveling on a laterally-inclined surface, such as an increase in the diameter of perimeter of the downhill wheel of a pair of shape-changing wheels when traveling on a laterally-inclined surface.

This present invention has several potential advantages over the nine categories of personal mobility devices in the prior art that we just reviewed. This present invention has advantages over devices with wheels with extendable/retractable spikes/spokes because it provides: continuous frictional transition from circular to non-circular shape; and a greater area of the wheel perimeter in contact with the travel surface. This present invention has advantages over devices with wheels with differentially inflatable/deformable perimeter segments because it enables: a wide range of angular perimeter shapes for hooking, grasping, and climbing obstacles; and rapid shape-changing capability for responding to unexpected changes in travel surfaces and obstacles. This present invention has advantages over devices with wheels with differentially-inflatable parallel adjacent tires because: it does not require multiple parallel wheels and a wide turning radius which are unacceptable for many applications; it offers a wide range of angular perimeter shapes for hooking, grasping, and climbing obstacles; and it provides rapid shape-changing capability for responding to unexpected changes in travel surfaces and obstacles.

This present invention has advantages over devices with wheels with foldable/bendable perimeter segments because: it avoids material and structural weakening due to repeated bending or folding; it has an explicit and adjustable mechanism for restoring the perimeter of the shape-changing wheel to circular shape. This present invention has advantages over devices with wheels with differentially-expandable concentric rings because: it offers a wide range of angular perimeter shapes for hooking, grasping, and climbing obstacles; and it provides rapid shape-changing capability for responding to unexpected changes in travel surfaces and obstacles. This present invention has advantages over devices with compound wheels or multiple interacting circular wheels because: it offers a wide range of angular perimeter shapes for hooking, grasping, and climbing obstacles; and it offers the simplicity, speed, and smooth ride of a single large wheel for traveling on flat, hard surfaces.

This present invention has advantages over devices with multiple interacting non-circular wheels because: it offers the simplicity, speed, and smooth ride of a single large wheel for traveling on flat, hard surfaces; and it does not require multiple serial or parallel wheels and a wide turning radius, which are unacceptable for many applications. This present invention has advantages over devices with endless-loop tracks because: it offers a wide range of angular perimeter shapes for hooking, grasping, and climbing obstacles; it offers the simplicity, speed, and smooth ride of a single large wheel for traveling on flat, hard surfaces; and it avoids the weight of multiple inner wheels and endless-loop tracks. This present invention has advantages over devices with walking legs because it offers; the simplicity, speed, and smooth ride of a single large wheel for traveling on flat, hard surfaces; a relatively small footprint and turning radius; and good frictional engagement on ice, snow, or other slippery surfaces.

### INTRODUCTION TO THE FIGURES

FIGS. 1 through 22 show multiple examples of ways in which this personal mobility device may be embodied, but these examples do not limit the full generalizability of the claims.

FIGS. 1 and 2 show an example of how the shape-changing wheel component of this personal mobility device may be embodied with three comma-shaped rotating members. FIG. 1 shows these three members in an inwardly-rotated circular configuration. FIG. 2 shows these three members in an outwardly-rotated non-circular configuration.

FIGS. 3 and 4 show an example of how the shape-changing wheel introduced in FIGS. 1 and 2 may be incorporated into a chair-like personal mobility device.

FIGS. 5 and 6 show an example of how the shape-changing wheel component of this personal mobility device may be embodied with four arcuate rotating members.

FIGS. 7 and 8 show an example of how the shape-changing wheel introduced in FIGS. 5 and 6 may be incorporated into a chair-like personal mobility device.

FIGS. 9 and 10 show an example of how the shape-changing wheel component of this personal mobility device may be embodied with eight comma-shaped rotating members.

FIGS. 11 and 12 show an example of how the shape-changing wheel introduced in FIGS. 9 and 10 may be incorporated into a personal mobility device that transports someone standing up.

FIGS. 13 and 14 show an example of how the shape-changing wheel shown in FIGS. 1 and 2 could be incorporated into a two-wheel chair-like mobility device whose stability is enhanced by a gyroscope and which enables someone to go up (or down) a flight of stairs independently.

FIGS. 15 and 16 show an example of how the shape-changing wheel component of this personal mobility device may be embodied with three arcuate rotating members that rotate around axels that are perpendicular and non-radial with respect to the main axel around which the wheel as whole rotates.

FIGS. 17 and 18 show an example of how the shape-changing wheel introduced in FIGS. 15 and 16 may be incorporated into a chair-like personal mobility device.

FIGS. 19 and 20 show an example of how a motorized personal mobility device with shape-changing wheels may have an automated means for changing the shape of those wheels in response to, or in anticipation of, different travel surfaces and obstacles.

FIGS. 21 and 22 show an example of how shape-changing wheels can be used to help prevent a device from tipping (over) on a laterally-inclined travel surface.

### DETAILED DESCRIPTION OF THE FIGURES

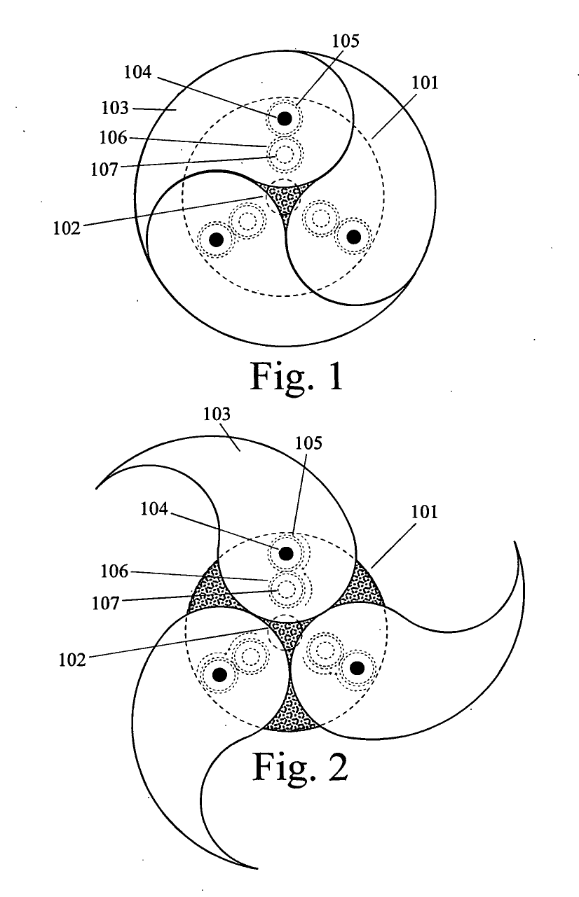

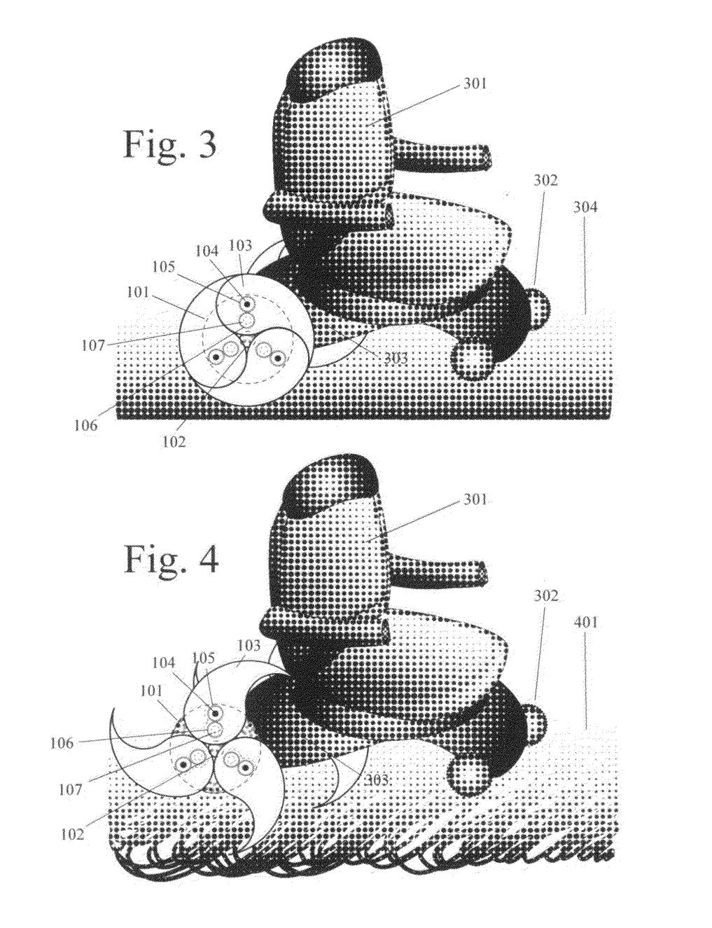

FIGS. 1 through 22 show multiple examples of ways in which this invention, a personal mobility device with one or more shape-changing wheels, may be embodied. However, these figures are only examples. These figures do not limit the full generalizability of the claims.

FIGS. 1 and 2 show one example of how the shape-changing wheel component of this personal mobility device may be embodied. The shape-changing wheel is a key element of a motorized wheeled device for transporting a person comprising: (a) a support structure that supports the person who is being transported; (b) a motor that moves the support structure by rotating at least one surface-contacting wheel, wherein the device travels on this surface; (c) at least one shape-changing wheel that changes shape to travel more effectively on different surfaces and obstacles; and (d) at least two rotating members that are part of this shape-changing wheel, wherein these rotating members are rotated by a motor, wherein this rotation can be independent of rotation of the wheel as a whole, wherein rotation of these rotating members into a first configuration causes the ground (or other travel surface) contacting perimeter of the wheel to be a first shape, wherein rotation of these rotating members into a second configuration causes the ground (or other travel surface) contacting perimeter of the wheel to be a second shape, and wherein the second shape is less circular than the first shape.

In the example shown in FIGS. 1 and 2, the shape-changing wheel includes three comma-shaped rotating members. These three rotating members combine to form the ground (or other travel surface) contacting perimeter of the wheel. FIG. 1 shows these three comma-shaped members in an inwardly-rotated first configuration. This first configuration forms a first shape. This first shape is a circular perimeter that creates a circular wheel. The combination of their shapes in this inward configuration is similar to a three-member version of the two-member “yin yang” symbol of Taoism. FIG. 2 shows these three comma-shaped rotating members having been rotated into an outwardly-rotated second configuration. This second configuration forms a second shape. This second shape is less-circular. In this example, this second shape is a saw-tooth wheel with three teeth. In the example shown in FIGS. 1 and 2, portions of the comma-shaped rotating members form some or all of the ground (or other travel surface) contacting perimeter of the shape-changing wheel in both the first configuration and the second configuration.

In the example shown in FIGS. 1 and 2, the rotating members are shaped like parts of a three-part “yin yang” symbol. In various alternative examples, the rotating members can have one or more shapes selected from the group consisting of: one part of a two-or-more-part “yin yang” symbol, tear-drop shape, comma shape, paisley shape, spiral galaxy arm shape, shark fin shape, saw tooth shape, ninja-star tooth shape, quadrilateral gear tooth shape, triangular gear tooth shape, sinusoidal gear tooth shape, peak shape with convex slopes on both sides, peak shape with concave slopes on both sides, and peak shape with convex slope on one side and concave slope on the other side. In the example shown in FIGS. 1 and 2, there are three rotating members that comprise a wheel with three major projections when they are all rotated into a second configuration. In other examples, there may be a different number (N) of rotating members that comprise a wheel with N major projections when they are all rotated into a second configuration.

In the example shown in FIGS. 1 and 2, the shape-changing wheel has an inner hub :101 that rotates around central axel 102. Each of the comma-shaped rotating members, including 103, is attached to inner hub 101 by a separate axel. For example, comma-shaped rotating member 103 is attached to inner hub 101 by axel 104. Comma-shaped member 103 is rotated by the rotation of gear 105 around axel 104. Gear 105 is rotated by the rotation of gear 106 that is attached to electric motor 107. Overall, the sequential chain of movement is as follows. Electric motor 107 rotates gear 106. The rotation of gear 106 rotates gear 105. The rotation of gear 105 rotates comma-shaped rotating member 103. The rotation of comma-shaped rotating member 103, combined with the similar rotation of the other two comma-shaped rotating members comprising this wheel, changes the shape of the wheel's perimeter from that of a circular first shape in FIG. 1 to that of a less-circular second shape in FIG. 2.

In the example shown in FIGS. 1 and 2, the comma-shaped rotating members, including 103, are rotated by inter-meshing gears, including gear 105. In alternative examples, the comma-shaped members could be rotated in other ways. In other examples, the comma-shaped members could be rotated by chain drives or belt drives. In this example, the comma-shaped rotating members, including 103, are rotated by rotational force applied to their axels. In other examples, the comma-shaped members could be rotated by force applied to their perimeters.

In the example shown in FIGS. 1 and 2, the intermeshing gears, including 105 and 106, are shown as being similar in size. In other examples, there can be variation in the gear ratio between the motors and the comma-shaped members and in the coordination of movement between different comma-shaped members. In other examples, the intermeshing gears may differ in size. For example, gear 106 may be smaller than gear 105 in order to provide more torque for rotating member 103. In this example, all rotating members are rotated by the same amount, but in symmetric directions. In other examples, different wheel shapes to better engage different environmental surfaces may be formed by rotating the rotating members in different directions or degrees.

In the example shown in FIGS. 1 and 2, the rotating members rotate around one or more axes that are different than the axis around which the wheel as a whole rotates. Further, these rotating members rotate around one or more axes that are substantially parallel to the axis around which the wheel as a whole rotates. In another example, the rotating members may rotate around one or more axes that are substantially perpendicular to the axis around which, the wheel as a whole rotates. In a further specification of this latter example, rotating members may rotate around one or more axes that are substantially perpendicular to the axis around which the wheel as a whole rotates, wherein the axes of these rotating members do not all extend radially outwards, in a spoke-like manner, from the axis around which the wheel as a whole rotates.

In the example shown in FIGS. 1 and 2, inner wheel hub 101 is parallel to and adjacent to the comma-shaped rotating members, including 103, and these comma-shaped rotating members are solid. In other examples, the inner portions of the rotating members could be hollow and inner wheel hub 101 could fit into them. In this latter example, both the rotating members and the inner wheel hub would fit within the same rotational plane. In this latter case, the wheel might not be as strong, but it could be thinner, which may be desirable for some applications.

In the example shown in FIGS. 1 and 2, rotation of the rotating members from a first configuration to a second configuration changes the wheel from a first shape to a second shape. This enables a motorized wheeled device to travel more effectively on different surfaces and obstacles. For example, the first shape shown in FIG. 1 is substantially circular in perimeter. This can enable a motorized wheeled device to travel more effectively over a flat, hard, dry surface. It provides relatively smooth and rapid travel over a relatively flat, hard, and dry surface. The second shape shown in FIG. 2 is non-circular. This can enable a motorized wheel device to travel more effectively over one or more surfaces or obstacles selected from the group consisting of: liquid, ice, snow, soil, mud, vegetation, gravel, rocks, curb, hill, and stairs.

In various examples, more effective travel on different surfaces and obstacles can be achieved by one or more means selected from the group consisting of: more grasping, hooking, or other engagement of a substantially level, but slippery, surface in order to provide better traction on that surface; more reaching, stepping, or climbing over an obstacle on an otherwise substantially level surface; more grasping, hooking, or other engagement of a higher surface in order to pull the device upwards onto that higher surface, such as more grasping, hooking, or other engagement of successive stair treads to pull the device up a flight of stairs; more grasping, hooking, or other engagement of a lower surface to controllably lower the device downwards onto that lower surface, such as more grasping, hooking, or other engagement of successive stair treads to controllably lower the device down a flight of stairs; and differential changes in the shapes of two or more shape-changing wheels in order to help prevent the device from tipping over when traveling on a laterally-inclined surface, such as an increase in the diameter of perimeter of the downhill wheel of a pair of shape-changing wheels on the same axel when traveling on a laterally-inclined surface.

In an example, rotation of the rotating members into a first configuration can cause the ground (or other travel surface) contacting perimeter of the wheel to be a first shape that is circular, rotation of these rotating members into a second configuration can cause the ground (or other travel surface) contacting perimeter of the wheel to be a second shape that is non- circular, portions of these rotating members form some or all of the ground (or other travel surface) contacting perimeter of the shape-changing wheel in both the first configuration and the second configuration, and these rotating members rotate around one or more axes that are different than the axis around which the wheel as a whole rotates.

In an example, motorized rotation of the rotating members shown in FIGS. 1 and 2 from a first configuration to a second configuration can be manually activated in order to travel more effectively on different surfaces and obstacles. For example, the person being transported by the device may manually activate rotation of these members to change the shape of the wheel from the first shape, shown in FIG. 1, to the second shape, shown in FIG. 2, in response to snow or ice on the ground over which device is traveling. In another example of manual activation, the person being transported by the device may activate rotation of these members to change the shape of the wheel from the first shape, shown in FIG. 1, to the second shape, shown in FIG. 2, in response to encountering a stair case. The device may then climb or descend the staircase using the second shape. In another example, a person accompanying the person being transported may manually activate the rotation of these members to change the shape of the wheel in response to different travel surfaces or obstacles.

In another example, motorized rotation of the rotating members shown in FIGS. 1 and 2 can be automatically activated. In various examples, motorized rotation of these rotating members can be automatically activated based on one or more factors selected from the group of factors consisting of: a change in the surfaces or obstacles that the device encounters based on information from a visual sensor; a change in the surfaces or obstacles that the device encounters based on information from an accelerometer; a change in the surfaces or obstacles that the device encounters based on information from an inclinometer; a change in the surfaces or obstacles that the device encounters based on information from infrared emissions; a change in the surfaces or obstacles that the device encounters based on information from acoustic emissions; a change in the surfaces or obstacles that the device encounters based on information from a map, blueprint, or GPS system; a change in the surfaces or obstacles that the device encounters based a change in the rotational speed of one or more wheels; and a change in the surfaces or obstacles that the device encounters based a change in the rotational resistance of one or more wheels.

We will now discuss some of the advantages of a personal mobility device that includes one or more shape-changing wheels, such as the wheel shown in FIGS. 1 and 2, over mobility devices in the prior art. In discussing the prior art, it is useful to categorize some of the most relevant prior art into general categories for comparison. Among the categories of prior art that are most relevant, we will now define and discuss (a) “extendable spike or spoke” mobility devices, (b) “tank chair” mobility devices, and (c) “extendable spoke track” mobility devices.

There are advantages of the present mobility device over “extendable spike or spoke” mobility devices in the prior art. “Extendable spike or spoke” devices have one or more wheels with spikes (or spokes) that can be changed from a first configuration in which the spikes are recessed below the main wheel perimeter to a second configuration in which the spikes protrude out from holes in the main wheel perimeter. One problem with such devices is that when the spikes (or spokes) extend out from the main wheel perimeter, there is a non-continuous transition from frictional engagement of the ground with the main wheel perimeter to frictional engagement with the, spikes (or spokes). This non-continuous transition can cause lose of frictional continuity and loss of device control. The present invention can avoid this problem by providing a smooth and continuous frictional transition. As shown in FIGS. 1 and 2, the rotating members can maintain continuous frictional contact with the surface as they rotate from a first configuration to a second configuration.

Another problem with “extendable spike or spoke” devices is that the total area of ground contact with extendable spikes (or spokes) is limited because the spikes (or spokes) must be able to be radially retracted into holes in the main wheel perimeter without jamming together. This is a major problem when the spike or spokes radially intersect in a retracted position. Also, the holes in the main perimeter through which the spikes (or spokes) extend cannot be too large or the main perimeter becomes structurally unstable. The present invention avoids these problems entirely.

There are variations on “extendable spike of spoke” devices in the prior art in which there is no main wheel perimeter, just a radial array of extendable/retractable spokes. One problem with this variation is that the person being transported is subjected to a bumpy, jarring ride on most surfaces. A second problem is the above-mentioned limitation on the total area of contact between the ground and the wheel. The only contact with the ground is the tips of the spikes or spokes. This is not good frictional engagement for acceleration or a quick stop. The present invention avoids both of these problems.

There are also advantages of the present mobility device over “tank chair” mobility devices in the prior art. “Tank chair” devices have endless-loop tracks around multiple inner-wheels, in a manner reminiscent of the endless-loop tracks used in military tanks. In some examples, these endless-loop tracks are the only method of ground contact for the device. In other examples, such tracks are used in combination with one or more wheels, in a manner reminiscent of “half-track” vehicles in the military.

A first problem with “tank chair” devices is that endless-loop tracks around multiple inner wheels tend to be heavy. Heavy devices consume more energy, deplete battery life, are dangerous to the person if they tip over, and are difficult to move in the event of motor failure or battery failure.

A second problem with “tank chair” devices is that it is difficult to operationalize tracks with projections that are sufficiently long and stiff and angular to provide safe and secure engagement with step treads for climbing steps. Track projections on such devices tend to be short and/or flexible. A device with short and/or flexible projections can be insufficient to safely grasp stairs. If the heavy device slips, it can topple down the stairs and crush the person being transported.

A third problem with “tank chair” devices is that they do not provide a circular wheel for smooth, rapid travel over a flat, hard surface.

A fourth problem with “tank chair” devices is that they are difficult to maneuver in sharp turns.

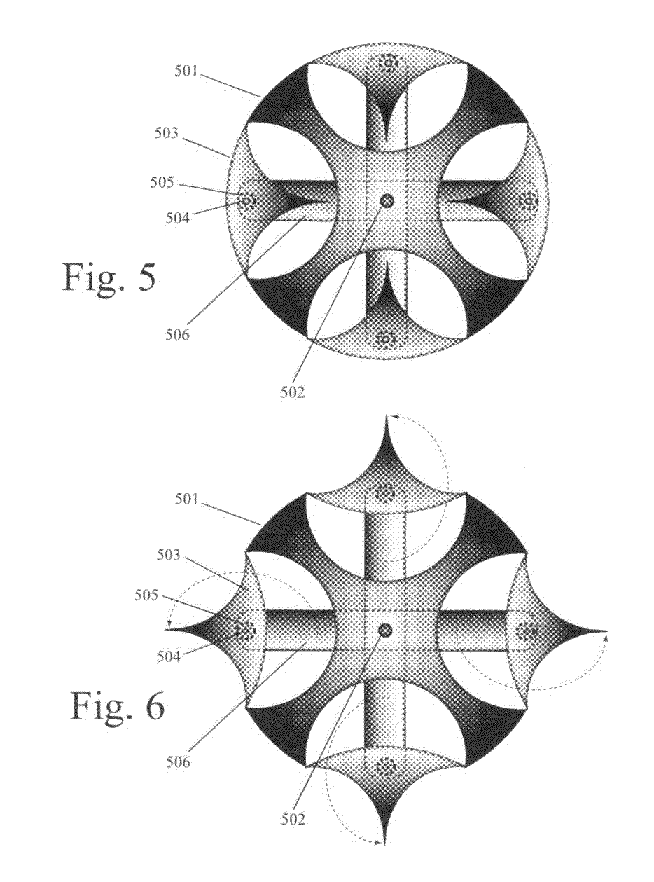

A fifth problem with “tank chair” devices is their military appearance. Some people may welcome the attention that comes with riding around in a device that looks like a military tank, but other people would not welcome such attention and would prefer a more conventional-looking device. It might be fun to ride a “tank chair” outdoors along muddy trails, but such a big device would be awkward an indoor office or mall environment. The present invention overcomes all of these problems. It offers the surface-engaging ability of a tank for uneven, slippery outdoor surfaces (FIG. 4), without giving up the conventional appearance of a regular wheelchair for flat, hard indoor surfaces (FIG. 3).

There are variations on “tank chair” devices in the prior art wherein the device has both an endless-loop track and a set of wheels. Sometimes these devices offer a mechanism for raising or lowering the track vs. wheels into contact with the ground. One problem with such devices is the weight and bulk required to have both wheels and tracks. A second problem is the frictional discontinuity in the transition from one to the other. A third problem is the limitation on the speed with which the device can transition from track to wheels in response to unexpected changes in travel surfaces or obstacles. A fourth problem is the above-mentioned limitation of tracks to safely engage stairs. The present invention overcomes all of these problems.

There are also hybrid “extendable spoke track” devices in the prior art. These hybrid “extendable spoke track” devices combine the extendable spikes or spokes of “extendable spike or spoke” devices with the endless-loop tracks of “tank chairs.” These “extendable spoke track” devices generally have an endless-loop track that is supported by multiple inner wheels which are, in turn, mounted on radially extendable or retractable spokes. When the spokes are differentially extended or retracted, the shape of the endless-loop track changes.

A first problem with “extendable spoke track” devices is the difficulty of creating an endless-loop track that can vary in length without mechanical failures and breakage. If one makes an endless-loop track that can stretch, then it can slip on the gear mechanisms that drive it and can suffer material fatigue and breakage. If one makes an endless-loop track that cannot stretch, then one needs a mechanism for storing slack and maintaining tension in smaller-perimeter configurations. Such storage mechanisms can be complex and, if they involve a combination of convex and concave loops, can easily be clogged by debris on the track. The present invention avoids these problems.

A second problem with “extendable spoke track” devices is the general limitation with tracks that was discussed above, especially as a mechanism for climbing or descending stairs. It is hard to have projections on tracks that are sufficiently long or rigid to engage stair treads. Even if the endless-loop track is supported by spokes that can be differentially extended or retracted, there is an inherent roundness in endless-loop tracks. This roundness comes from the constraints on link bending in such tracks. Due to the constraints on link bending in tracks, there are limits on the creation of acute-angle projections (such as claws, hooks, teeth, or protruding arms) that would be useful for firmly grasping surfaces such as stair treads. The present invention overcomes both of these problems. The present invention enables a variety of claws, hooks, teeth, and protruding arms to firmly grasp stair treads and prevent the device from sliding down a flight of stairs.

FIGS. 3 and 4 show one example of how the shape-changing wheel that was introduced in FIGS. 1 and 2 may be incorporated into a chair-like personal mobility device. This motorized wheeled device for transporting a person comprises: (a) a support structure that supports the person who is being transported; (b) a motor that moves the support structure by rotating at least one surface-contacting wheel, wherein the device travels on this surface; (c) at least one shape-changing wheel that changes shape to travel more effectively on different surfaces and obstacles; and (d) at least two rotating members that are part of this shape-changing wheel, wherein these rotating members are rotated by a motor, wherein this rotation can be independent of rotation of the wheel as a whole, wherein rotation of these rotating members into a first configuration causes the ground (or other travel surface) contacting perimeter of the wheel to be a first shape, wherein rotation of these rotating members into a second configuration causes the ground (or other travel surface) contacting perimeter of the wheel to be a second shape, and wherein the second shape is less circular than the first shape.

In the example shown in FIGS. 3 and 4, the support structure of the device transports a person in a seated posture. In various examples, the support structure may support the person being transported in one or more of the following postures: seated, standing up, and lying down.

In the example shown in FIGS. 3 and 4, a chair-like support structure 301 is connected to two regular (non-shape-changing) front wheels (including 302), a motor-containing base member 303, and two shape-changing rear wheels. In this example, the right shape-changing wheel is comprised of parts 101 through 107, as introduced in FIG. 1. In this example, the motor within motor-containing member 303 moves the device by rotating the shape-changing wheels.

FIG. 3 shows a flat, hard, and dry travel surface, 304, over which the device is travelling. For example, this may be an indoor surface, such as the floor of an office or mall or home. For such a surface, a circular wheel provides the most effective travel. A circular wheel provides smooth, rapid transportation over a flat, hard, dry surface. Accordingly, the comma-shaped rotating members of the shape-changing wheel are in a first configuration, wherein they comprise a circular wheel, to optimally travel on the flat, hard, dry surface. This personal mobility device offers the advantages of a conventional motorized wheelchair (in terms of speed, smooth ride, turning radius, and conventional appearance) for travel on a flat, hard, and dry travel surface.

FIG. 4 shows how the shape-changing wheel enables this device to change in order to travel more effectively over an uneven or slippery surface. FIG. 4 shows a travel surface 401 which is uneven or slippery. In various examples, this travel surface may be selected from the group consisting of: liquid, ice, snow, soil, mud, vegetation, gravel, and rocks. In FIG. 4, the comma-shaped rotating members of the shape-changing wheel, including 103, have been rotated outwards into a second configuration wherein they comprise a saw-tooth wheel. This saw-tooth wheel can better engage liquid, ice, snow, soil, mud, vegetation, gravel or rocks to provide better traction and/or obstacle-climbing ability. In a variation on this example, the upper portion of the shape-changing wheel may be covered by a shielding member that protects people from contact with the moving portions of the shape-changing wheel. As an example of the latter, the shape-changing wheel could have an upper wheel well that shields the person from movement of the saw-tooth wheel. This personal mobility device offers the advantages of a “tank chair” (in terms of frictional engagement and obstacle-climbing) for travel on an uneven or slippery travel surface.

In the example shown in FIGS. 3 and 4, this personal mobility device has a set of regular (non-shape-changing) wheels in the front and a set of two shape-changing wheels in the rear which propel it. In another example, the device could have two sets of regular wheels, one set in the front and one set in the rear, with a set of two propelling shape-changing wheels in the middle. In another example, the stability of the device may be enhanced by use of a gyroscope. With gyroscopically-enhanced stability, the device could be propelled by a set of two shape-changing wheels in the middle and no regular wheels at all. This can open up a variety of options for stair-climbing and tight turns. In the example shown in FIGS. 3 and 4, both of the shape-changing wheels change shape in a similar manner at the same time. In other examples, two or more shape-changing wheels could change into different shapes in order to more effectively travel on different surfaces or obstacles. For example, if the device were traveling over a laterally-inclined surface (such as hill that causes the chair to tilt to the right or left), then the right and left shape-changing wheels might change into shapes with different size perimeters to keep the chair upright. This can help to prevent the device from tipping over (to the right or left) when traveling on a laterally-inclined surface. As another example, if the right wheel of the device were to encounter snow or ice, but not the left wheel, then the device might sense this and only change the shape of the right shape-changing wheel so as to achieve optimal overall device traction and control.

In an example, motorized rotation of the rotating members can be manually activated to travel more effectively on different surfaces and obstacles. For example, the person being transported by the device may see the change from travel surface 304 to travel surface 401 and then activate the shape-changing wheels. The person may manually activate rotation of these members to change the shape of the rear wheels for more effective travel over travel surface 401. In another example, motorized rotation of the rotating members can be automatically activated. For example, a visual sensor may detect the change from flat, hard travel surface 304 to uneven, slippery travel surface 401 and automatically change the shape of the rear wheels. In other examples, accelerometers or inclinometers or infrared emission or acoustic emission may detect the change from travel surface 304 to 401. In other examples, the device may communicate with a digital building blueprint, digital map, or GPS system to automatically anticipate changes in travel surfaces (or obstacles) and change the shape-changing wheels in advance of actually encountering these surfaces (or obstacles).

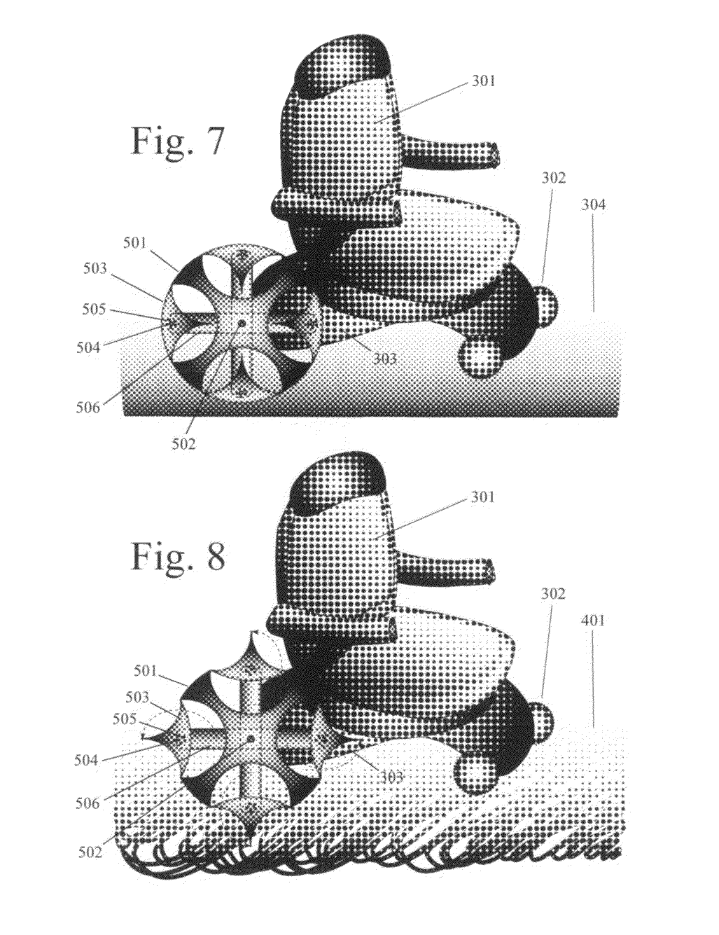

FIGS. 5 and 6 show another example of how the shape-changing wheel component of this personal mobility device may be embodied. In the example shown in FIGS. 5 and 6, the shape-changing wheel includes four arcuate rotating members, including member 503. These arcuate rotating members have three arcuate sides—two sides that are concave and one side that is convex. When an arcuate member is rotated so that its convex side faces outwards from the wheel center, then the convex side forms part of the ground (or other travel surface) contacting perimeter of a circular wheel. When an arcuate member is rotated so that its concave sides face outwards from the wheel center, then the concave sides form part of a generally square-shaped wheel with spike-like projections at the four corners. The latter shape can provide enhanced traction or climbing functionality, on demand, for travel over uneven surfaces, slippery surfaces, or surface obstacles.

Similar to the shape-changing wheel shown in FIGS. 1 and 2, the wheel in FIGS. 5 and 6: includes rotating members that rotate around axes that are different from, but parallel to, the central axis, 502, around which the wheel as a whole rotates; and has rotating members that form part of the ground (or other travel surface) contacting perimeter of the wheel in all rotational configurations. Unlike the shape-changing wheel shown in FIGS. 1 and 2, the interior of the shape-changing wheel in FIGS. 5 and 6 is not solid. The one or more shape-changing wheels for this invention may be embodied in shape-changing wheels that are solid, such as that in FIGS. 1 and 2, or in shape-changing wheels that are not solid, such as that in FIGS. 5 and 6.

In the example shown in FIGS. 5 and 6, the shape-changing wheel has an “X”-shaped support member, 501. This “X”-shaped support member has four convex ends that form part of the ground (or other travel surface) contacting perimeter of the wheel. The convexity of these four ends is designed so that these four convex ends form parts of a circular perimeter when the arcuate rotating members between them are rotated such that the convex sides of the rotating members face outwards. This example also includes four fixed-length spokes, including 506. These fixed-length spokes hold the four axels, such as 504, for the four arcuate rotating members. The four arcuate rotating members rotate around these axels, changing from a first configuration, as shown in FIG. 5, to a second configuration, as shown in FIG. 6. In this example, the first configuration causes the wheel perimeter to assume a first shape, a circle, and the second configuration causes the wheel perimeter to assume a second shape, a rough square with spiked corners.

In the example shown in FIGS. 5 and 6, the rotating arcuate members are rotated separately by four separate motors, including motor 505. In other examples, the rotating arcuate members could be rotated by a single motor, with force distributed from the single motor to four axes by means of a chain drive or belt drive. In other examples, the four arcuate members could be rotated by force applied to their perimeters.

In the example shown in FIGS. 5 and 6, there are four arcuate rotating members that comprise a generally-square wheel when their concave sides are rotated outwards. In other examples, there may be a different number (N) of rotating members that comprise a generally N-sided wheel when their concave sides are rotated outwards, where N could be 3 or 5 or more.

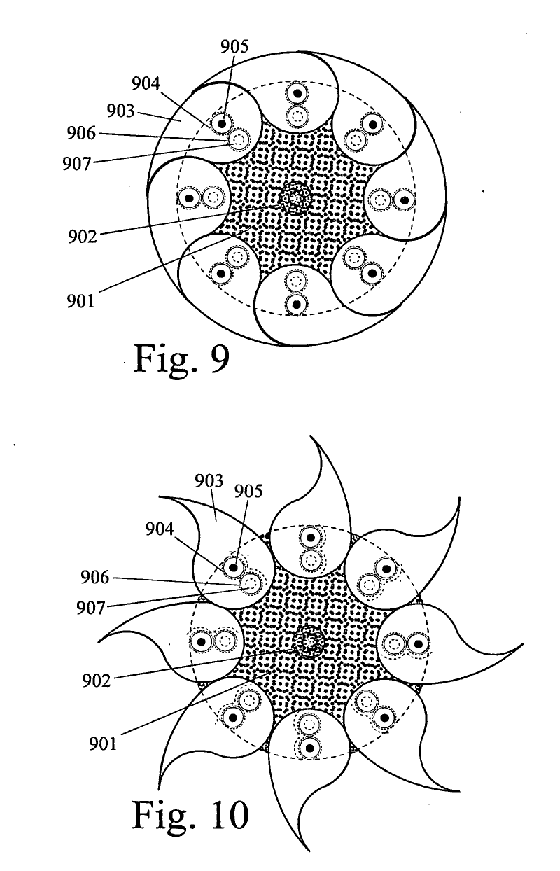

FIGS. 7 and 8 show one example of how the shape-changing wheel shown in FIGS. 5 and 6 could be incorporated into a chair-like personal mobility device. In this example, the support structure of the device transports a person in a seated posture. In various examples, the support structure may support the person being transported in one or more of the following postures: seated, standing up, and lying down.

In the example shown in FIGS. 7 and 8, a chair-like support structure 301 connected to two regular (non-shape-changing) front wheels (including 302), a motor-containing base member 303, and two shape-changing rear wheels. In this example, the right shape-changing wheel is comprised of parts 501 through 506, as introduced in FIG. 5. In this example, the motor within motor-containing base member 303 moves the device by rotating the shape-changing wheel. FIG. 7 shows a flat, hard, and dry travel surface, 304, over which the device is travelling. A circular wheel provides smooth, rapid transportation over a flat, hard, dry surface.

FIG. 8 shows how the shape-changing wheel of FIGS. 5 and 6 can enable this device to change in order to travel more effectively over an uneven or slippery surface. FIG. 8 shows a travel surface 401 which is uneven or slippery. In various examples, this travel surface may be selected from the group consisting of: liquid, ice, snow, soil, mud, vegetation, gravel, and rocks. In FIG. 8, the four arcuate rotating members of the shape-changing wheel, including 503, have been rotated outwards into a second configuration wherein they comprise a generally square-shaped wheel with spiked corners. This generally-square shape can better engage liquid, ice, snow, soil, mud, vegetation, gravel or rocks to provide better friction and/or obstacle-climbing ability.

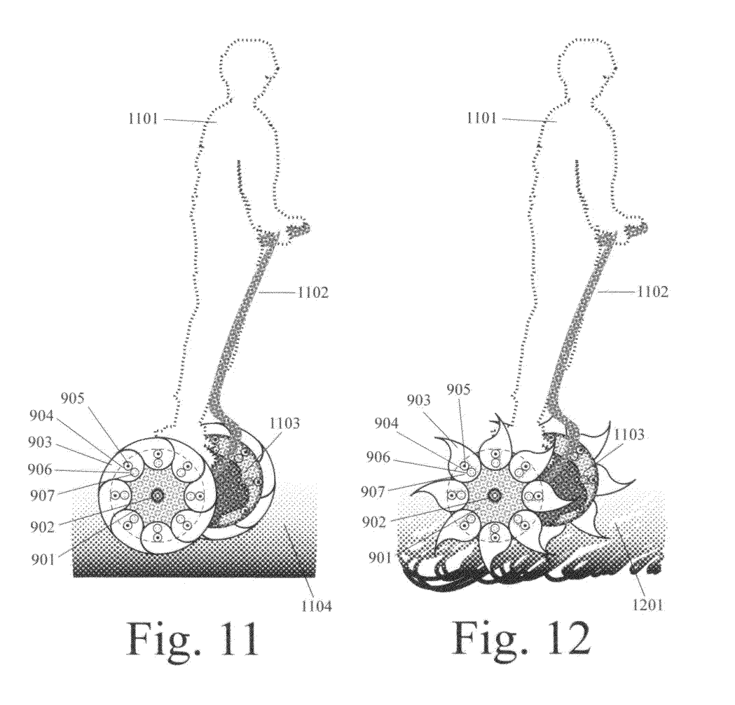

FIGS. 9 and 10 show another example of how the shape-changing wheel component of this personal mobility device may be embodied. This example is similar to the example shown in FIGS. 1 and 2, except that now the shape-changing wheel has a greater number of comma-shaped rotating members, including 903. In this example, there are eight comma-shaped rotating members instead of three. A potential advantage of having a larger number of comma-shaped rotating members is a smoother ride when these members are extended outwards. Another potential advantage of having a larger number of rotating members is easier application to two-wheel mobility devices with little or no wheel hub, especially those whose stability is enhanced by a gyroscope. A potential disadvantage of having a shape-changing wheel with a larger number of rotating members, such as the eight shown in FIGS. 9 and 10, is that it could be less effective for climbing stairs as compared to a shape-changing wheel with a smaller number of larger rotating members, such as the three member wheel shown in FIGS. 1 and 2.

As was the case in FIGS. 1 and 2, the comma-shaped rotating members in FIGS. 9 and 10 combine to form the ground (or other travel surface) contacting perimeter of the shape-changing wheel. FIG. 9 shows these eight comma-shaped rotating members in an inwardly-rotated first configuration that creates a circular wheel. This shape-changing wheel has an inner hub 901 that rotates around a central axel 902. Each of the comma-shaped rotating members, including 903, is attached to inner hub 901 by a separate axel. For example, comma-shaped rotating member 903 is attached to inner hub 901 by axel 905. Comma-shaped member 903 is rotated by the rotation of gear 904 around axel 905. Gear 905 is rotated by the rotation of gear 906 that is attached to electric motor 907. Overall, the sequential chain of movement is as follows. Electric motor 907 rotates gear 906. The rotation of gear 906 rotates gear 904. The rotation of gear 904 rotates comma-shaped rotating member 903. The rotation of comma-shaped rotating member 903, combined with the similar rotation of the seven other comma-shaped rotating members comprising this wheel, changes the shape of the wheel's perimeter from that of a circular first shape in FIG. 9 to that of a less-circular second shape in FIG. 10. In alternative examples, the comma-shaped members could be rotated in other ways. In other examples, the comma-shaped members could be rotated by chain drives or belt drives. In other examples, the comma-shaped members could be rotated by force applied to their perimeters.

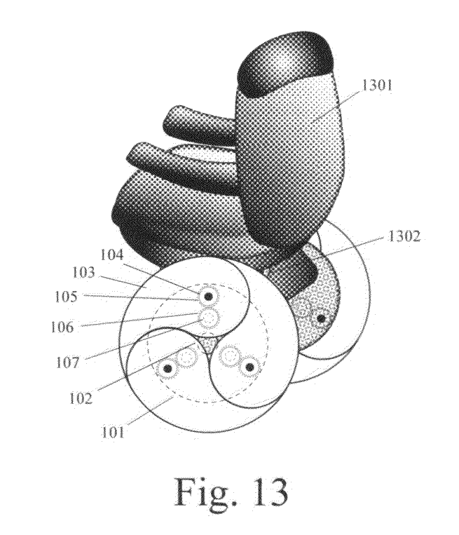

FIGS. 11 and 12 show one example of how the shape-changing wheel shown in FIGS. 9 and 10 could be incorporated into a two-wheel personal mobility device whose stability is enhanced by a gyroscope. In this example, the support structure of the device transports a person in a standing posture. In various examples, the support structure may support the person being transported in one or more of the following postures: seated, standing up, and lying down.

In the example of this device shown in FIGS. 11 and 12, a standing person 1101 is shown traveling with their feet on a gyroscopically-enhanced platform 1103 and grasping a cross-bar handle mounted on a vertical rod 1102 that is attached to platform 1103. The gyroscopically-enhanced platform helps to maintain the device in an upright position. In this example, there are two shape-changing wheels attached to the gyroscopically-enhanced platform, wherein each of these shape-changing wheels is comprised of parts 901 through 907, as introduced in FIG. 9. In this example, a motor within gyroscopically-enhanced platform 1103 moves the device by rotating the shape-changing wheels. FIG. 11 shows a flat, hard, and dry travel surface, 1104, over which the device is travelling. The circular wheels provide smooth, rapid transportation over this flat, hard, dry surface.

FIG. 12 shows how the shape-changing wheel of FIGS. 9 and 10 can enable this device to change in order to travel more effectively over an uneven or slippery surface. FIG. 12 shows a travel surface 1201 which is uneven or slippery. In various examples, this travel surface may be selected from the group consisting of: liquid, ice, snow, soil, mud, vegetation, gravel, and rocks. In FIG. 12, the eight comma-shaped rotating members of the shape-changing wheel, including 903, have been rotated outwards into a second configuration wherein they comprise a less-circular wheel with spiked projections. The shape with spiked projections can better engage liquid, ice, snow, soil, mud, vegetation, gravel or rocks to provide better friction and/or obstacle-climbing ability.

In the example shown in FIGS. 11 and 12, the shapes of both the right and left shape-changing wheels are changed in a similar and simultaneous manner in order to provide better traction, or other obstacle-traversing capability, when both wheels encounter liquid, ice, snow, soil, mud, vegetation, gravel or rocks. In another example, the shapes of the right and left shape-changing wheels may be changed in dissimilar manners, or at different times, in order to provide better traction when only one wheel encounters such surfaces. In another example, when the mobility device traverses a laterally-inclined surface, the diameter of only the downhill wheel (either right or left, depending on the angle of inclination) may be increased in order to help the device from tipping laterally (either to the right or to the left).

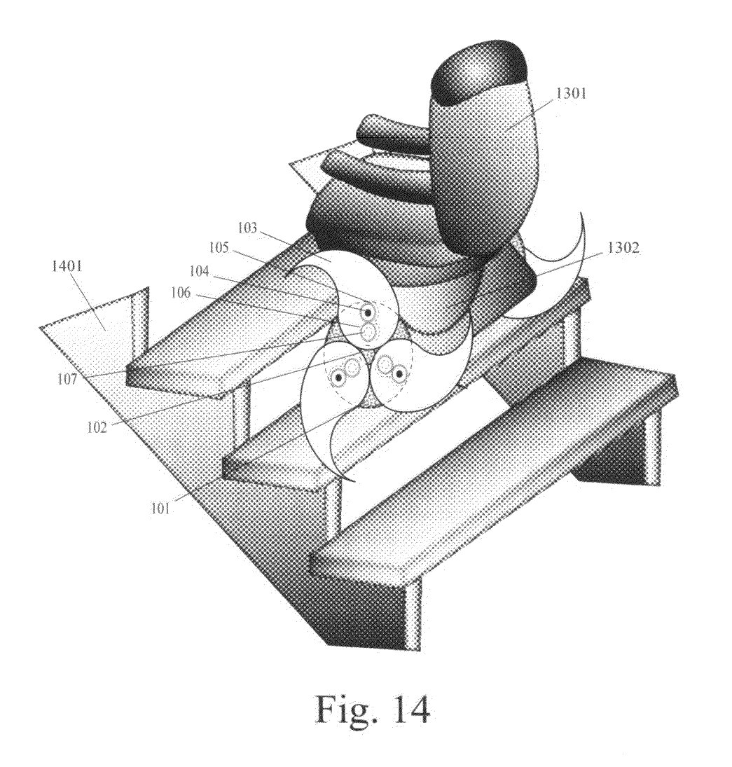

FIGS. 13 and 14 show an example of how the shape-changing wheel shown in FIGS. 1 and 2 could be incorporated into a two-wheel chair-like mobility device whose stability is enhanced by a gyroscope. In this example, the support structure of the device transports a person in a seated posture.

FIG. 13 shows a chair-like support structure 1301 on top of a base 1302, wherein this base includes both a motor to power a set of shape-changing wheels and a gyroscope to keep chair-like support 1301 upright and balanced. Each of the shape-changing wheels is formed from members 101 through 107 that were introduced in FIG. 1. These shape-changing wheels have three comma-shaped rotating members, including 103, that can be rotated inwards to form a circular wheel, as shown in FIG. 13, or rotated outwards to form a non-circular wheel with three major projections, as shown in FIG. 14.

FIG. 14 shows the same chair-like example that was introduced in FIG. 13, but in FIG. 14 the configuration of the shape-changing wheel has been changed to enable the device to climb up a set of stairs. It would have been difficult, if not impossible, for this device to climb stairs with a set of circular wheels because circular wheels would not have been able to hook, grasp, or otherwise engage the stair treads to pull the chair upwards. However, the three-member saw-tooth wheel that is formed when the comma-shaped rotating members are rotated is able to hook or grasp successive stair treads and pull the chair upwards on the staircase. In this example, use of a gyroscope to maintain stability combined with use of a non-circular wheel shape enables the device to transport a person up or down stairs.

In the example shown in FIG. 14, a chair-like device, for which stability is enhanced by a gyroscope and grasping is enhanced by a shape-changing wheel, transports a person up or down a flight of stairs while they are seated. In another example, a platform-like device with a vertical rod and handle, for which stability is enhanced by a gyroscope and grasping is enhanced by a shape-changing wheel, could transport a person up or down a flight of stairs while they are standing up. In another example, a stretcher-like device, for which stability is enhanced by a gyroscope and grasping is enhanced by a shape-changing wheel, could transport a person up or down a flight of stairs while they are lying down.

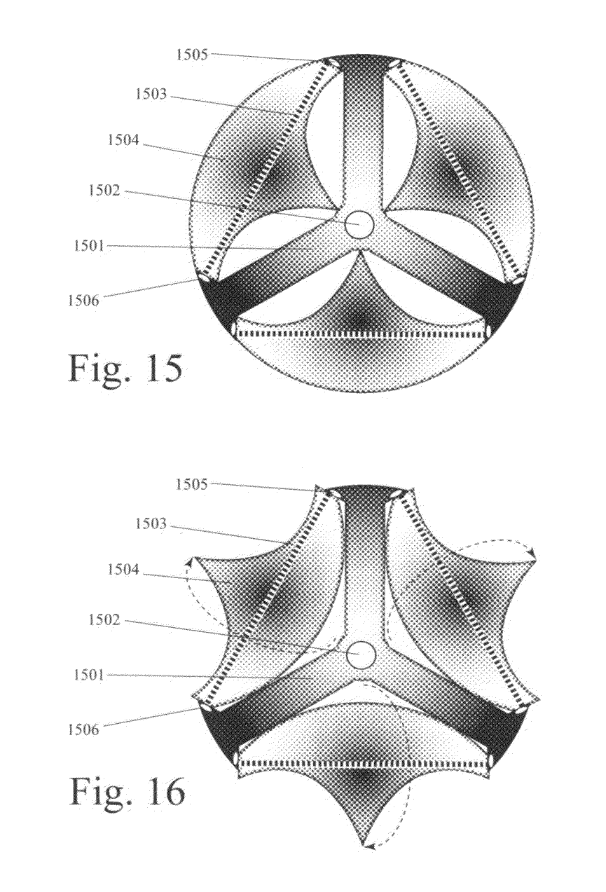

FIGS. 15 and 16 show another example of how the shape-changing wheel component of this personal mobility device may be embodied. This example has three arcuate rotating members, including arcuate member 1504, that rotate around axels, including axel 1503, that are perpendicular and non-radial with respect to the main axel, 1502, around which the wheel as whole rotates. In various examples, rotating members may rotate around one or more axes that are substantially perpendicular to the axis around which the wheel as a whole rotates. In a further specification of this latter example, rotating members may rotate around one or more axes that are substantially. perpendicular to the axis around which the wheel as a whole rotates, wherein the axes of these rotating members do not all extend radially outwards, in a spoke-like manner, from the axis around which the wheel as a whole rotates.

The perimeters of the arcuate rotating members in FIGS. 15 and 16, including arcuate member 1504, have three primary sides and two secondary sides. The three primary sides include two concave sides and one convex side. The two secondary sides are short, parallel flat sections through which the rotational axel protrudes. When an arcuate member is rotated such that its convex side faces outward from the wheel center, then the convex side becomes part of the ground (or other travel surface) contacting perimeter of a circular wheel. When an arcuate member is rotated such that the two concave sides face outwards from the wheel center, then these concave sides become part of a fin-toothed wheel with three spike projections. FIG. 15 shows these arcuate rotating members in an inwardly-rotated first configuration that creates a circular wheel. FIG. 16 shows these arcuate rotating members in an outwardly-rotated second configuration that creates a less circular wheel.

In the example shown in FIGS. 15 and 16, the shape-changing wheel has a three-arm hub, 1501 that rotates around main axel 1502. The three rotating arcuate members, including 1504, rotate around three axels, including axel 1503, that are turned by motors, including motors 1505 and 1506. In this manner, the motors rotate the rotating arcuate members, including 1504, from the first configuration shown in FIG. 15 to the second configuration shown in FIG. 16.

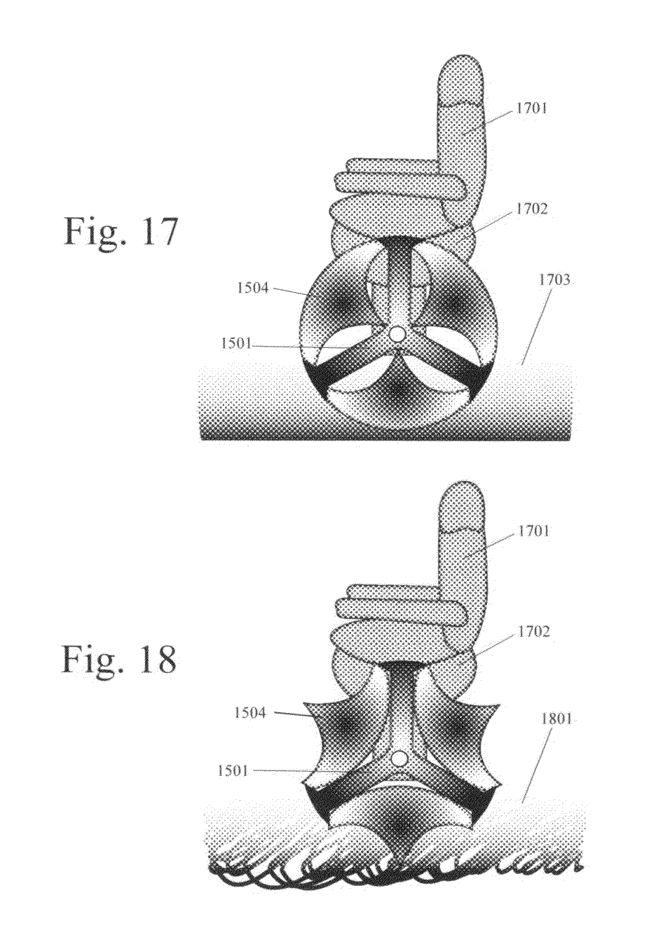

FIGS. 17 and 18 show an example of how two shape-changing wheels, such as the one shown in FIGS. 15 and 16, can be used in combination with a chair-like support structure, 1701, and a base, 1702, that includes a motor to power the wheels and a gyroscope to keep chair-like support upright and balanced. FIG. 17 shows this example with the shape-changing wheels configured into a circular shape to optimally travel over hard, flat, dry surface 1703. FIG. 18 shows this example with the shape-changing wheels configured into a non-circular, spiked shape to optimally travel over uneven, slippery surface 1801.

The examples shown in FIGS. 1 through 18 demonstrate some ways of embodying a method of increasing the effectiveness of a wheeled device for transporting a person on different surfaces and obstacles comprising: (1) providing a support structure to support the person; (2) moving this support structure by rotating at least one wheel with a motor; (3) changing the shape of at least one wheel to travel more effectively on different surfaces and obstacles; and (4) rotating at least two members that are part of this shape-changing wheel, wherein these rotating members are rotated by a motor, wherein this rotation can be independent of rotation of the wheel as a whole, wherein rotation of these rotating members into a first configuration causes the perimeter of the wheel to be a first shape, wherein rotation of these rotating members into a second configuration causes the perimeter of the wheel to be a second shape, and wherein the second shape is less circular than the first shape.

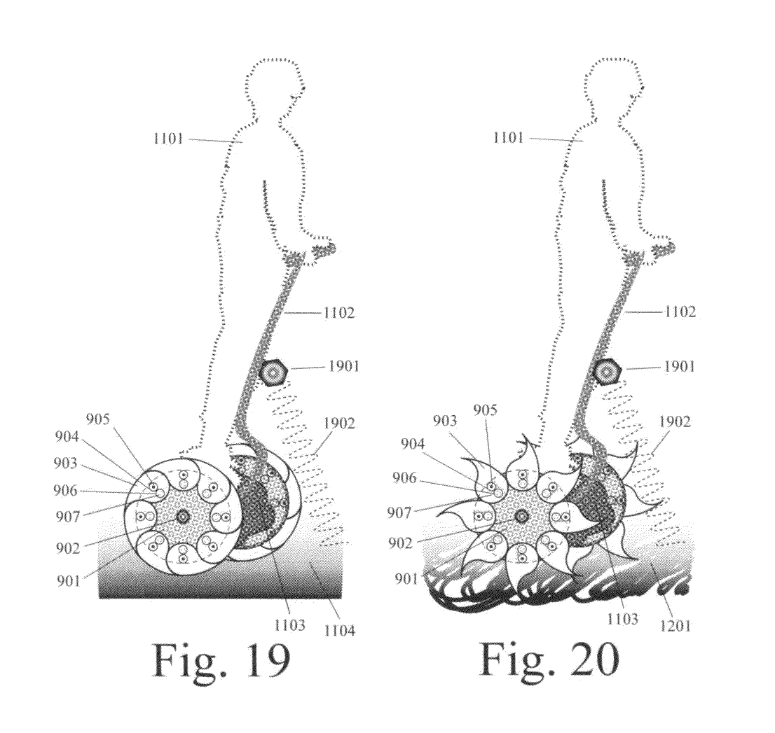

FIGS. 19 and 20 show an example of how a motorized personal mobility device with shape-changing wheels may have an automated means for changing the shape of those wheels in response to, or in anticipation of, different travel surfaces and obstacles. FIG. 19 shows an example of a gyroscopically-enhanced personal mobility device with two-shaped shape-changing wheels that transports a person, 1101, who is standing up. This example is the same as the one introduced in FIG. 11, except for the addition of a visual information member, 1901, that collects and analyzes visual information, 1902, concerning the surface, 1104, over which the device is traveling. In FIG. 19, visual information member 1901 visually observes and recognizes surface 1104 as being flat and dry. Accordingly, it maintains the shape-changing wheels, wherein each one is comprised of parts 901 through 907, in circular configurations. In FIG. 20, visual information member 1901 visually observes and recognizes surface 1201 as being uneven and slippery. Accordingly, it changes the shapes of the shape-changing wheels, in real time, into non-circular configurations to provide greater traction. In this example, there are no wheel wells covering the top portions of the shape-changing wheels. In another example, there can be wheel wells covering the top portions of the shape-changing wheels.

In the example shown in FIGS. 19 and 20, motorized rotation of the rotating members is automatically activated by a change in the surfaces or obstacles that the device encounters based on information from a visual sensor. In various examples, motorized rotation of these rotating members can be automatically activated based on one or more factors selected from the group of factors consisting of: a change in the surfaces or obstacles that the device encounters based on information from a visual sensor; a change in the surfaces or obstacles that the device encounters based on information from an accelerometer; a change in the surfaces or obstacles that the device encounters based on information from an inclinometer; a change in the surfaces or obstacles that the device encounters based on information from infrared emissions; a change in the surfaces or obstacles that the device encounters based on information from acoustic emissions; a change in the surfaces or obstacles that the device encounters based on information from a map, blueprint, or GPS system; a change in the surfaces or obstacles that the device encounters based a change in the rotational speed of one or more wheels; and a change in the surfaces or obstacles that the device encounters based a change in the rotational resistance of one or more wheels.

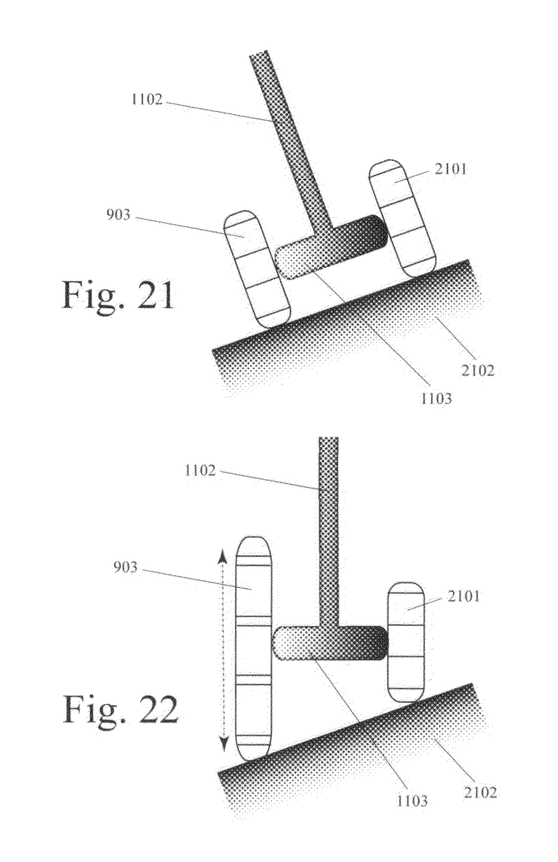

FIGS. 21 and 22 show an example of how shape-changing wheels, such as the one introduced in FIGS. 9 and 10 can be applied to the two-wheel gyroscopically-enhanced mobility device introduced in FIGS. 11 and 12 in order to help prevent the device from tipping (over) on a laterally-inclined travel surface. In the example shown in FIGS. 21 and 22, the shapes of two shape-changing wheels are changed differently in order to help prevent the device from tipping over when traveling on a laterally-inclined surface. Specifically, FIG. 21 shows an increase in the diameter of the downhill wheel of a pair of shape-changing wheels when the device is traveling on a laterally-inclined surface.

Specifically, FIG. 21 shows one shape-changing wheel, including rotating member 903 such as the one introduced in FIG. 9, on the right side of the two-wheeled device. The device includes vertical rod 1102 and gyroscopically-enhanced platform 1103. FIG. 21 also shows an identical shape-changing wheel, including rotating member 2101, on the left side of this two-wheeled device. FIG. 21 shows this personal mobility device with two shape-changing wheels traveling on a laterally-inclined surface 2102. In FIG. 21, the two wheels are the same diameter, like regular non-shape-changing wheels, and the inclination of surface 2102 causes platform 1103 and vertical rod 1102 to tip to the right. If the inclination is sufficiently large, then the personal mobility device may tip over.

FIG. 22 shows this same personal mobility device after the shape-changing abilities of the two shape-changing wheels have been utilized. In this example, the shapes of the two wheels have been differentially changed. In this example, the diameter of the downhill (right) wheel has been increased automatically by outward rotation of the eight rotating members on it, including rotating member 903. However, the shaped of the uphill (left) wheel has been left unchanged. This differential increase in the diameter of the right wheel, but not the left wheel, offsets the inclination of surface 2102 so that the platform 1103 and vertical rod 1102 of the device remain upright and the danger of tipping over is reduced.

In an example, this differential increase in the diameter of the downhill wheel shown in FIG. 22 may be, automatically activated by information from an inclinometer mounted on the device. In another example, this differential increase in the diameter of the downhill wheel may be automatically activated by information from a visual sensor. In another example, this differential increase may be manually activated by the person being transported.

I claim:

1. A motorized wheeled device for transporting a person comprising:
a support structure that supports the person who is being transported;
a motor that moves the support structure by rotating at least one wheel;
at least one shape-changing wheel that changes shape to travel more effectively on different surfaces and obstacles;
and at least two rotating members that are part of this shape-changing wheel, wherein these rotating members are rotated by a motor, wherein this rotation can be independent of rotation of the wheel as a whole, wherein rotation of these rotating members into a first configuration causes the perimeter of the wheel to be a first shape, wherein rotation of these rotating members into a second configuration causes the perimeter of the wheel to be a second shape, and wherein the second shape is less circular than the first shape.

2. The rotating members in claim 1 wherein portions of these rotating members form some or all of the perimeter of the shape-changing wheel in both the first configuration and the second configuration.

3. The rotating members in claim 1 wherein portions of these rotating members form some or all of the ground (or other travel surface) contacting perimeter of the shape-changing wheel in both the first configuration and the second configuration.

4. The rotating members in claim 1 wherein these rotating members rotate around one or more axes that are substantially parallel to the axis around which the wheel as a whole rotates.

5. The rotating members in claim 1 wherein these rotating members rotate around one or more axes that are substantially perpendicular to the axis around which the wheel as a whole rotates.

6. The rotating members in claim 5 wherein these rotating members rotate around one or more axes that are substantially perpendicular to the axis around which the wheel as a whole rotates, and wherein the axes of these rotating members do not all extend radially outwards, in a spoke-like manner, from the axis around which the wheel as a whole rotates.

7. The rotating members in claim 1 wherein motorized rotation of these members is manually activated to travel more effectively on different surfaces and obstacles.

8. The rotating members in claim 1 wherein motorized rotation of these members is automatically activated to travel more effectively on different surfaces and obstacles.

9. The automatic activation in claim 8 wherein this activation is based on one or more factors selected from the group of factors consisting of: a change in the surfaces or obstacles that the device encounters based on information from a visual sensor; a change in the surfaces or obstacles that the device encounters based on information from an accelerometer; a change in the surfaces or obstacles that the device encounters based on information from an inclinometer; a change in the surfaces or obstacles that the device encounters based on information from infrared emissions; a change in the surfaces or obstacles that the device encounters based on information from acoustic emissions; a change in the surfaces or obstacles that the device encounters based on information from a map, blueprint, or GPS system; a change in the surfaces or obstacles that the device encounters based a change in the rotational speed of one or more wheels; and a change in the surfaces or obstacles that the device encounters based a change in the rotational resistance of one or more wheels.

10. The first shape in claim 1 wherein this shape enables the device to travel more effectively over a flat, hard, dry surface.

11. The second shape in claim 1 wherein this shape enables the device to travel more effectively over one or more surfaces or obstacles selected from the group consisting of liquid, ice, snow, soil, mud, vegetation, gravel, rocks, curb, hill, and stairs.

12. The device in claim 1 wherein use of a gyroscope to maintain stability combined with use of a non-circular second shape enables the device to transport a person up or down stairs.

13. The support structure in claim 1 wherein this structure supports the person being transported in one or more of the following postures: seated, standing up, and lying down.

14. The device in claim 1 wherein the upper portion of the shape-changing wheel is covered by a shielding member that protects people from contact with the moving portions of the shape-changing wheel.

15. The device in claim 1 wherein two or more shape-changing wheels change into different shapes in order to more effectively travel on different surfaces or obstacles.

16. The device in claim 1 wherein more effective travel is achieved by one or more means selected from the group consisting of: more grasping, hooking, or other engagement of a substantially level, but slippery, surface in order to provide better traction on that surface; more reaching, stepping, or climbing over an obstacle on an otherwise substantially level surface; more grasping, hooking, or other engagement of a higher surface in order to pull the device upwards onto that higher surface, such as more grasping, hooking, or other engagement of successive stair treads to pull the device up a flight of stairs; more grasping, hooking, or other engagement of a lower surface to controllably lower the device downwards onto that lower surface, such as more grasping, hooking, or other engagement of successive stair treads to controllably lower the device down a flight of stairs; and differential changes in the shapes of two or more shape-changing wheels in order to help prevent the device from tipping over when traveling on a laterally-inclined surface, such as an increase in the diameter of perimeter of the downhill wheel of a pair of shape-changing wheels when traveling on a laterally-inclined surface.

17. The device in claim 1 wherein the shapes of two or more shape-changing wheels are changed differently in order to help prevent the device from tipping over when traveling on a laterally-inclined surface, such as an increase in the diameter of the downhill wheel of a pair of shape-changing wheels when traveling on a laterally-inclined surface.

18. The device in claim 1 wherein the rotating members have one or more shapes selected from the group consisting of: one part of a two-or-more-part “yin-yang” symbol, tear-drop shape, comma shape, paisley shape, spiral galaxy arm shape, shark fin shape, saw tooth shape, ninja-star tooth shape, quadrilateral gear tooth shape, triangular gear tooth shape, sinusoidal gear tooth shape, peak shape with convex slopes on both sides, peak shape with concave slopes on both sides, and peak shape with convex slope on one side and concave slope on the other side.

19. A motorized wheeled device for transporting a person comprising:
a support structure that supports the person who is being transported;
a motor that moves the support structure by rotating at least one surface-contacting wheel, wherein the device travels on this surface;
at least one shape-changing wheel that changes shape to travel more effectively on different surfaces and obstacles;
and at least two rotating members that are part of this shape-changing wheel, wherein these rotating members are rotated by a motor, wherein this rotation can be independent of rotation of the wheel as a whole, wherein rotation of these rotating members into a first configuration causes the ground (or other travel surface) contacting perimeter of the wheel to be a first shape that is circular, wherein rotation of these rotating members into a second configuration causes the ground (or other travel surface) contacting perimeter of the wheel to be a second shape that is non-circular, wherein portions of these rotating members form some or all of the ground (or other travel surface) contacting perimeter of the shape-changing wheel in both the first configuration and the second configuration, and wherein these rotating members rotate around one or more axes that are different than the axis around which the wheel as a whole rotates.

20. A method of increasing the effectiveness of a wheeled device for transporting a person on different surfaces and obstacles comprising:
providing a support structure to support the person;
moving this support structure by rotating at least one wheel with a motor;
changing the shape of at least one wheel to travel more effectively on different surfaces and obstacles;
and rotating at least two members that are part of this shape-changing wheel, wherein these rotating members are rotated by a motor, wherein this rotation can be independent of rotation of the wheel as a whole, wherein rotation of these rotating members into a first configuration causes the perimeter of the wheel to be a first shape, wherein rotation of these, rotating members into a second configuration causes the perimeter of the wheel to be a second shape, and wherein the second shape is less circular than the first shape.
